(19) United States
(12) Patent Application Publication
(10) Pub. No.: US 2015/0231896 A1
(43) Pub. Date: Aug. 20, 2015

(54) INVERTED CODES ON TRANSPARENT PACKAGING EXTERIOR

(71) Applicant: Fastechnology Group, LLC, Glen Carbon, IL (US)

(72) Inventors: Joseph A. Hattrup, Plano, TX (US); Ralph P. French, Maryville, IL (US); Nathaniel Evert Lawson, Collinsville, IL (US)

(21) Appl. No.: 14/700,409

(22) Filed: Apr. 30, 2015

Related U.S. Application Data
(63) Continuation-in-part of application No. 14/574,872, filed on Dec. 18, 2014.
Application No. 14/574,872 is a continuation-in-part of application No. 14/202,982, filed on Mar. 10, 2014.
Application No. 14/202,982 is a continuation-in-part of application No. 13/417,593, filed on Mar. 12, 2012, now abandoned.
(60) Provisional application No. 61/987,029, filed on May 1, 2014.
(60) Provisional application No. 61/944,939, filed on Feb. 26, 2014.
(60) Provisional application No. 62/062,611, filed on Oct. 10, 2014.
(60) Provisional application No. 61/799,284, filed on Mar. 15, 2013.
(60) Provisional application No. 61/558,533, filed on Nov. 11, 2011.
(60) Provisional application No. 61/451,225, filed on Mar. 10, 2011.

(51) Int. Cl. B41J 3/407

(52) U.S. Cl. CPC B41J 3/407

(57) ABSTRACT

The system and method make individualized product packages. A memory device stores a plurality of different, unique, individual, inverted codes. A first printer prints the inverted codes on an exterior of packages on-the-fly and a second printer prints a background layer over the inverted codes. A controller linked to the memory device and the printers controls the operation of the printers to print the inverted codes and background layer at a selected transparent or translucent position on the packages.

### BACKGROUND OF THE INVENTION

The present invention generally relates to database driven systems and methods of manufacturing, marking (including labeling), packaging, distributing, tracking and/or collecting feedback of customized, individualized, personalized consumer products in-line during the actual packaging process, grouping, cartoning and eventual palletization. In particular, the present invention relates to on-the-fly systems and methods which print individual codes covered by a background layer on an exterior transparent or translucent portion of a package.

A media component has been included in batches of printed documents, such as disclosed in U.S. Pat. No. 6,240,334, incorporated herein in its entirety by reference. However, such components are not personalized based on the recipients, demographics or customers and the individual documents are not unique or uniquely tracked. In addition, such components provide no feedback and do not lend themselves to precision tracking, inline versioning, targeted distribution and/or targeted promotions.

### SUMMARY OF THE INVENTION

In one form, a system is provided for use with a continuous, in-line moving web from which successive product packages are formed and filled with products. A memory device stores a plurality of code images. A frame receives and supports the web of packages including guides for guiding the web through the frame as the web moves through the frame. A first printer supported by the frame prints a code on an exterior surface of each package on-the-fly as the web moves through the frame. A second printer supported by the frame prints a background layer over each printed code on the exterior surface on each package on-the-fly as the web moves through the frame. A sensor senses a location of the web relative to the printers. A system controller linked to the sensor, linked to the memory device, and linked the printers controls the operation of the printers in response to the sensor to print a selected code and background layer at locations along the web. As a result, individual, successive product packages on the web wherein each package includes a code overlaid by a background layer on the exterior surface of the package is provided.

In one form, the codes are inverted and printed on a transparent or translucent portion of a package.

In one form, the invention comprises a corresponding method.

Other objects and features will be in part apparent and in part pointed out hereinafter.

### BRIEF DESCRIPTION OF THE DRAWINGS

FIG. 1 is a block diagram of one embodiment of a system and method of the invention for the manufacture of custom products and/or custom packages based on consumer and retailer information and based on demographic product and/or package information.

FIG. 2 is a block diagram of one embodiment of a system and method of the invention for the manufacture, distribution and tracking of a custom sports drink with custom marks based on local teams and retailer information and based on previous purchase history of the sports drink.

FIG. 3 is a perspective view of one embodiment of a product line according to the invention.

FIGS. 4A and 4B are illustrations of embodiments of a route sequenced, customized pallet according to the invention.

FIG. 5 is an illustration of one embodiment of the invention incorporated within a packaging line providing products with a private label gaming and targeted promotion initiative for a convenience store. In particular, FIG. 5 illustrates an embodiment with an applied scratch-off layer printed on packages.

FIG. 6 is an illustration of one embodiment of the invention added to an existing packaging line, such as a form, fill and seal machine. In this embodiment, a mobile personalization module (MPM) is added to the existing packaging line to add a private label, gaming and/or targeted promotion or initiative to the packaging of products as the products are being manufactured. In particular, FIG. 6 illustrates an embodiment with an applied thermal transfer overprinting (TTO) layer applied to packaging on the fly as the packaging is being prepared to receive products.

FIG. 7 illustrates a stand-alone module for use in conjunction with a typical roll of product packaging material (PPM) packages, according to one embodiment of the invention.

FIG. 8 is a view of the stand-alone module of FIG. 7 taken along lines 8-8 of FIG. 7.

FIG. 9 is a partial side view of the stand-alone module of FIG. 7.

FIG. 10 is a partial side view of the thermal transfer overprinter and the web of PPM package after the images and scratch layer have been applied.

FIG. 11 is a plan view of an image on a web, according to one embodiment of the invention.

FIG. 12A is a plan view of the image of FIG. 11, with part of the scratch layer removed.

FIGS. 12B and 12C are a plan view of an instant win version and a non-instant win version of FIG. 12A.

FIG. 13 is a block diagram of the stand-alone module of FIG. 7, according to one embodiment of the invention.

FIG. 14 is a block diagram of one embodiment of a system and method of the invention for the manufacture of CPG products having custom ingredients, optionally based on at least one of consumer information, retailer information, demographic product information and demographic package information.

FIG. 15 illustrates a front perspective view another embodiment of a stand-alone module for use in conjunction with a typical web of product packaging material (PPM) packages, according to one embodiment of the invention.

FIG. 16 illustrates a front side elevational view of the module of FIG. 15.

FIG. 17 illustrates a top elevational view of the module of FIG. 15.

FIG. 18 illustrates a right side elevational view of the module of FIG. 15.

FIG. 19 illustrates a bottom elevational view of the module of FIG. 15.

FIG. 20 illustrates a rear perspective view of the module of FIG. 15.

FIG. 21 illustrates a rear side elevational view of the module of FIG. 15.

FIG. 22 is an illustration of one embodiment of the invention added to a form, fill and seal machine.

FIG. 23 is a photo of an exemplary web for use in a form, fill & seal machine for create a package, the web having an address and a graphics image printed thereon in accordance with the methods and systems herein.

FIG. 24 is a photo of the front of an exemplary form, fill & seal package having a lotion sample therein and having been formed from the web pictured in FIG. 23.

FIG. 25 is a photo of the back of the exemplary form, fill & seal package having a lotion sample therein pictured in FIG. 24 and having been formed from the web pictured in FIG. 23.

FIG. 26 illustrates one embodiment of a system of the invention for printing individual QR codes on a continuous web from which individual consumer packages are formed. A database cross-references the QR code of each package to its unique package parameters. The package parameters includes one of more of manufacturing parameters, material parameters and/or distribution parameters.

FIG. 27 illustrates one embodiment of a system of the invention for printing individual QR codes on individual consumer packages after the packages are manufactured. A database cross-references the QR code of each package to its unique package parameters. The package parameters include one of more of manufacturing parameters, material parameters and/or distribution parameters.

FIG. 28 includes exemplary images of inverted codes for printing on an exterior surface of transparent packaging. The inverted codes are overlaid by a background substantially opaque layer of ink on which another layer of ink as text in is applied. The inverted codes are readable only from the interior of the transparent packaging.

FIG. 28A includes exemplary images of negative, inverted codes for printing on an exterior surface of transparent packaging. The negative, inverted codes are overlaid by a background layer on which another layer of ink as text in is applied. The negative, inverted codes are readable only from the interior of the transparent packaging.

FIG. 28B includes exemplary images of inverted, negative codes for printing on an exterior surface of transparent packaging. The inverted, negative codes are overlaid by a background layer on which another layer of ink as text in is print applied ed. The negative, inverted codes are readable only from the interior of the transparent packaging.

FIG. 29 illustrates a stand-alone module for use in conjunction with a typical roll of product packaging material (PPM) packages, according to another embodiment of the invention, in which a code, a background layer and a text layer are sequentially applied to the exterior surface of a transparent portion of PPM.

FIG. 30 is a view of the stand-alone module of FIG. 29 taken along lines 30-30 of FIG. 29, showing a QR code, a solid, opaque, background layer applied over the QR code and a text message M layer of ink applied on the background layer.

FIG. 31 is a partial side view of the thermal transfer overprinter and the web of PPM package after the code, background layer and text have been applied.

Corresponding reference characters indicate corresponding parts throughout the drawings.

### DETAILED DESCRIPTION

The present invention includes inline filling and packaging process systems and methods which allow customized products to be tailored to each store, which matches preferences to local store demographics and/or which supports the local causes in which shoppers are interested. Systems and methods of the invention enable manufacturers to produce retail-ready personalized packaging (RRPP) which are produced and may be tracked from the beginning of the manufacturing process through to the retail outlet. In addition, the systems and methods provide marketing tools to track feedback by the consumer regarding a specific customized product (e.g., customized package) received by the consumer. In one form, RRPP is defined as: consumer package products which have been produced to provide custom content which may include individualized, variable, internal configurations as well as variable imaging on the packaging which is targeted to a geographic or demographic market segment, produced in such a way that on-the-fly production is sequenced for efficient delivery with bulk shipping units (pallets). The pallets are constructed such that they require minimal handling for the retail environment while maintaining superior marketability. RRPP is produced through a continuous process, minimizing or eliminating costly factory line changeovers.

Systems and methods of the invention enable manufacturers to create precise retailer-specific, demographically tailored RRPP unique to channel and trade partners, and uniquely compelling to consumers. In one embodiment, systems and methods of the invention enable manufacturers to create products matched to individual shopper psychographics and palletized to specific store-level demographics and produced in delivery route sequence. In some embodiments, systems and methods of the invention enable manufacturers to build mixed-case pallets in the warehouse for each account and load trucks based on stops, rather than by SKU. Instead of a forecast-order-shipping model, systems and methods of the invention enable manufacturers to implement a replenishment model based on actual demand. The manufacturer may then replenish stock every few days or even every day based on what is sold and adjusted for special circumstances, like a promo.

In general, in one aspect, systems and method of the invention individually track each product from manufacture to its destination on the pallet. This allows the systems and methods to produce individually customized products wherein each product may have a different version. Different versions of a product include:
(a) products having different internal configurations and different packaging (e.g., variable imaging on the packaging), or
(b) products having the same internal configuration and different packaging, or
(c) products having different internal configurations and the same packaging.
   For example, if the product is a sport drink, it could have different colors (e.g., ingredients) and different packaging or it could have the same color with different packaging or it could have different colors and the same or similar packaging.

Thus, systems and methods of the invention can produce the following types of route sequenced customized pallets:
(1) one pallet having multiple versions of a product (e.g., different ingredients and/or different packaging) on the same pallet. This one pallet has products for delivery to multiple destinations. For example, certain tiers or cases from the pallet are intended for delivery to a particular retailer. Other tiers or cases from the same pallet are intended for delivery to a different retailer. Each tier or case may be composed of the same or different versions of a product.
(2) one pallet having multiple versions of a product on the same pallet. This one pallet is for delivery to one retailer. For example, one pallet intended for a particular retailer would have different versions of a product.
(3) multiple pallets and multiple versions of a product are produced with only one version of the product on each pallet. Each pallet would have a specific destination. For example, one pallet having one version of a product would go to the one retailer and another pallet having a different version of the product would go to a different retailer.

### Database Driven System and Method

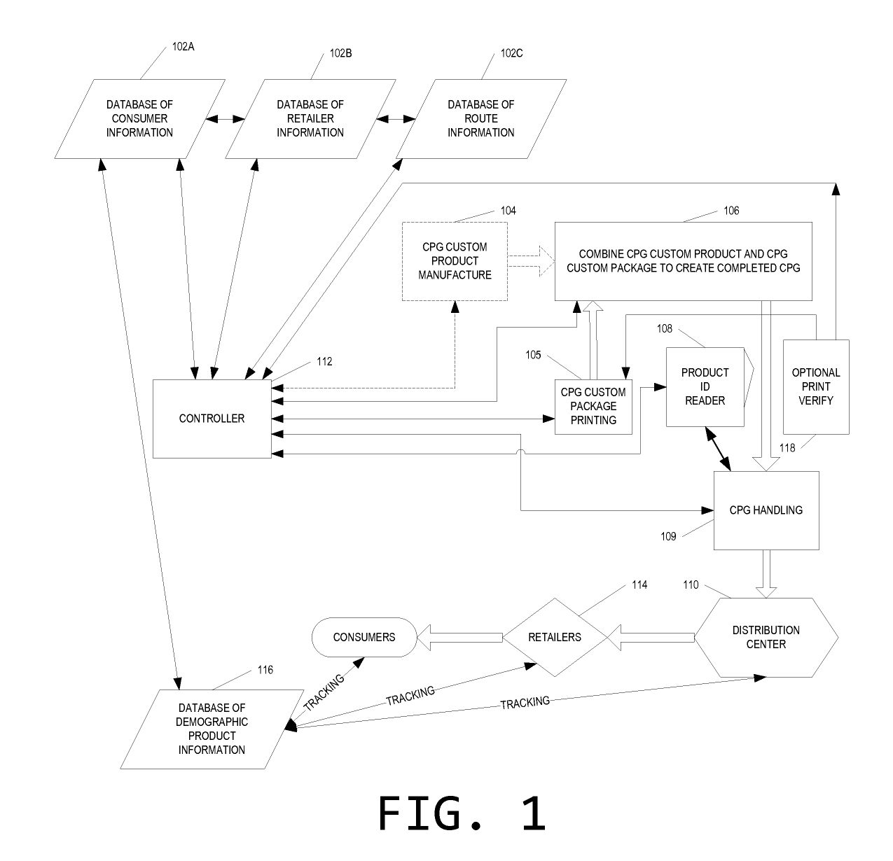

In this embodiment as illustrated in FIG. 1, a database driven system and method of consumer based information is used to control and produce on the fly variable imaging of product packaging and on the fly routing of products after imaging so that individual products may be tracked. This intelligent system includes a database having regional information and/or individual information about consumers. This information would be linked to various individualized or regionalized packaging graphics to be added to packages. For example, the packaging could be customized for a particular retail outlet based upon known demographics or database. Various levels of granularity are contemplated. The database would also provide routing information (which could be printed on the packaging) to direct the customized products to stores in specific geographic locations adjacent to specific demographic concentrations. As a specific example, packaging may be customized for a particular local event, such as a music festival, i.e., localized segmenting, to provide a personal experience and ties to the community. Alternatively, the database information could be used to direct custom printed packaging into batches of products, each batch to be sent to one of various, particular locations such that they are produced on the line in Route Sequenced order. Route sequenced order provides the additional efficiency of being able to deliver targeted product (retail ready pallets) to end destinations without extra handling. Alternatively, packaging may include customized tracking which may or may not be embedded in coupon information.

Further to the description of embodiment, above, the manufacturing process may be controlled to provide customized product makeup or content based upon information contained within the database, such that each individual destination could have a customized makeup or selection of components within the package which in turn contains the data base driven imaging. This technique could also be utilized on a product by product basis and combined with the variable imaging to produce several unique products concurrently from a single manufacturing line. The synchronization of the customized product makeup and customized imaging provide additional benefits over each component separately.

As illustrated in FIG. 1, system 101 includes a database 102 including consumer, retailer and/or route information. For example, the database 102 may have a data record A of a consumer A served by a first retailer, a data record B of a consumer B served by the first retailer, a data record C of a consumer C served by a second retailer and data record D of a consumer D served by the second retailer, wherein the data records are different from each other, wherein the consumers are different from each other, and wherein the retailers are different from each other. The system also includes a product supply system 104 for supplying a product A associated with the data record A, for supplying a product B associated with the data record B, for supplying a product C associated with the data record C, and for supplying a product D associated with the data record D. In one embodiment, the supply system 104 may be a CPG custom product manufacturing system, although it is also contemplated that products may be pre-manufactured.

Next, a marking system 106 applies a unique identifier to each unit of the products. The identifier may be a variable image printed on the packaging or on a label applied to the existing packaging of the product. For example, the identifier may be one or more of: a QR (quick response) 2-dimensional bar code; an RFID tag or code; a unique pattern or graphic which can be uniquely identified (e.g., a picture of a person which can be identified by face recognition software); an infrared code; and/or other markings, either visible or not within the visible light spectrum. Alternatively or in addition, a system can also track unit products by encoding, tracking and monitoring the linear movement of each uniquely identified unit thereby knowing the location of each unit at any instant in time. Alternatively or in addition, the marking may be a label having one or more of the above.

In addition, the marking system 106 may combine a consumer package goods (CPG) custom product with a CPG custom package to create a completed CPG with unique elements. For example, the marking system applies an element A including information A from the data record A to the product A, applies an element B including information B from the data record B to the product B, applies an element C including information C from the data record C to the product C, and applies an element D including information D from the data record D to the product D, wherein the information is different from each other and wherein the elements are different from each other, and/or wherein the products are different from each other. As shown in FIG. 1, it is also contemplated that the marking system 106 may be part of a CPG custom package printing 107.

Alternatively, the marking system 106 may have several subsystems located at different places. For example, the CPG custom product manufacturing system 104 may add the unique identifier to each product and the CPG custom package printing system and/or the marking system 106 may applied the unique elements to each package, based on the package record.

Next, an identification system 108, such as a product ID reader, identifies each of the products A, B, C, D so that CPG handling 109 via a distribution center 110 is able to individually distributes each of the identified products A and B to the first retailer and for distributing the identified products C and D to the second retailer. In one embodiment, the distribution system would include a CPG handling system and a distribution center.

### Database Populated Based on Product Tracking and Feedback

In this embodiment as illustrated in FIG. 1, product packaging is imaged with variable content prior to delivery to the packing line. Each product package type is uniquely identified so that each type of product package can be tracked. As each product is produced the individual identification is read by the identification system 108 and associated with the database 102 which may contain data related to the date, time of manufacture, the machine which produced the product, raw materials or components used in the production, quality parameters reported from the production process as well as data for custom content, image files and data which may be printed on the product during the manufacturing and packaging process. Logistical information related to distribution such as the intended destination is tracked by the controller 112 and the line is controlled to provide route sequenced product pallets.

Products are shipped to distribution centers 110 and then delivered to retailers 114. When products are scanned and sold by a retailer, the information is collected by the retailer and provided as feedback to be added to a database 116. The product packaging may also include a coupon or other feature such as a barcode or a QR code that can be tracked when redeemed or scanned by a consumer 120. The feature would provide feedback for database 116. The database 116 would allow the collection of logistical information regarding the point of purchase as compared to the demographic information connected to various products, packaging, customers and their locations. For example, a certain area having a high purchase rate of a particular type of product and/or packaging would suggest that other similar products and/or packages should be targeted to the certain area. The feedback and tracking information in database 116 may be used by database 102 to provide similar products and/or packages in the future so that future products are produced and distributed based on the feedback and tracking information. Also, database 116 can easily define quantities needed at a particular location and the most effective product mix based on past sales and feedback.

In one embodiment, the packaging may include promotions which direct a consumer to a website (e.g., a social networking site such as facebook.com) to provide direct consumer feedback. When using the website, the user would identify the particular package by its codes, such as by scanning or providing the number of the code. Thus, the feedback provided by the consumer could be matched to individual package.

### Variable Data Printing—Tracking Each Product

Historically, variable print applications within the CPG processes relate to time, lot or batch and are not product specific on an individual, on-the-fly, piece by piece basis. An important feature of implementation of embodiments of the invention is that the variable print by the marking system 106, which may include a CPG custom package printing system, be controlled by controller 112 on a piece by piece basis, driven from a database file of database 102. According to the invention, each individual product (not a batch) is individually tracked throughout the process and system as shown in FIGS. 1-3. One way of tracking is that each individual product carries a unique, individual identifier, such as a bar code, a QR (quick response) mark, a 2-d bar code, an RFID tag, a pattern or graphic which could be matched (e.g., image recognition), an infrared code, some other marking not within the visible light spectrum or any other marking or tracking. For example, the system can also track each product by its unique chain space position (linear tracking) as it progresses through the system.

Each individual product has an individual data file unique to it and associated with it. The data file contains the print data, sequencing information and other control information which is further disclosed and described herein.

In one embodiment, the mark used to track each product is applied to the product as part of its manufacture by system 104 and/or as part of the printing of is packaging as printed by system 107. Alternatively or in addition, pre-printed packaging or labels may be used to uniquely identify each package.

Historically, CPG processes utilize a homogenous product and process, such that each product that comes off of the line is as like the next as possible. The RRPP process provides for the ability to create product (e.g., packaging) which may vary in content, or appearance on a piece by piece basis, although it is contemplated that two different uniquely marked products may have at least some similar aspects or may be identical except for their unique id mark. The specific variable content may include an individual component, ingredient or a selection of physical components and can also include messaging, imaging, or attaching supplemental marks and is an integral part of each pieces data within the data base. The database file for a particular product may include a PCT (Product Configuration Type) Code which may include a binary map to indicate which components, ingredients, or processes each piece will receive or which may include a discrete code which is referenced to a data table which contains the specific content for each PCT.

### Synchronous and Asynchronous Process Tracking

Individualized and customized products require precise tracking of each individual piece throughout the manufacturing process. Tracking individual products is done with one or more of the following schemes:

Synchronous product tracking methodology includes using incremental and absolute positioning encoders to track motion of the products and manufacturing lines. For example, photocells and cameras (product verification devices) are used in conjunction with discrete tracking logic to verify that products reach each check point (product verification check-point). If a product does not reach a verification point within a predetermined window of machine motion, it is faulted and no further processes will be initiated on that product/position on the line. The product that was faulted will be reordered and remanufactured via the information for that product within the data file.

Asynchronous product tracking methodology includes using variable data print technology to print a specific number or code to identify each individual piece. The code is referenced back to the database so each time that product code is detected via a barcode reader or camera based vision device, it can be validated for proper sequence, position and can be resynchronized for additional product specific process to be applied to the product.

### Fields for Data Base Driven Manufacturing

The production of customized sequenced products requires the associated database 102 which contains the specific instructions on how the product will be customized, processed and handled. These instructions are encoded within fields within the database 102. These fields may include but are not limited to:

Data Fields: Data fields contain printable text and may also contain specific format information related to the text regarding font, size, orientation, and position of each unique unit of product.

Image Fields: Similar to data fields, image fields include variable images for each unit of product and may be cross linked to an associated image file. Using this methodology keeps the database smaller in size by putting the large graphic files in a separate file which may be stored in a separate location or even on the printer which will print the image. Storing the data on the printer also minimizes the amount of data which must be transferred for each product/print event.

PCT Field: Product Configuration Type fields contain the information which drives the variable content and process controls.

Packaging Control: This field contains information that is used for subsequent processing including stacking, carton and pallet control. The designations within this field are used to determine the end of carton/destination groupings for the control of downstream handling devices. In addition in the event of a reorder, when the replacement part is made, it is referenced to the products currently being manufactured to determine if it needs additional handling or if it can be included in the current destination grouping.

Location Fields: This field identifies pallet location and product location on the pallet.

Destination Field: This field identifies the final destination of a product or pallet.

### Types of Records

In one embodiment, the data format defines types of records which are used by the controller 112 and/or by one or more of local controllers of the various subsystems (e.g., manufacture 104, marking 106, identification 108, CPG handling 109), including one or more of:
Production Records
Customer/Profile Records
Delivery Route Information
Retail Unit Information
Message Records
Setup Records
File Identification Records
Block Status Records

A Production Record contains most or all of the data needed to produce one product. It contains the data for one subscriber or customer such as name and address. The format and contents of Production Records are discussed later in this document.

A Message Record contains fixed text data that may be used for one or more products. It contains fixed text data such as a message or announcement that is to be printed on multiple products. The format and contents of Message Records are discussed later in this document.

A Setup Record contains system setup data. For example, this data may specify demographic makeup codes and pocket assignments, or the placement of print on the products. Various production runs may require different system setups. The operator could enter this data by hand via the user interface, or load a setup file instead. The format and contents of Setup Records are discussed later in this document.

A File Identification Record (or File ID Record) contains identification information about the disk or tape file. On magnetic tape media, a File ID Record separates the tape files in a multi-file volume. The format and contents of File ID Records are later in this document.

A Block Status Record applies to disk files only. It is used to delimit a disk file in a way that is similar to the blocking method of records on a magnetic tape. When transferring a tape file to disk, there would be one Block Status Record for each Physical Tape Block (PTB) on the magnetic tape. The Block Status Record contains the tape read status for the corresponding PTB. The format and contents of Status Records are discussed later in this document.

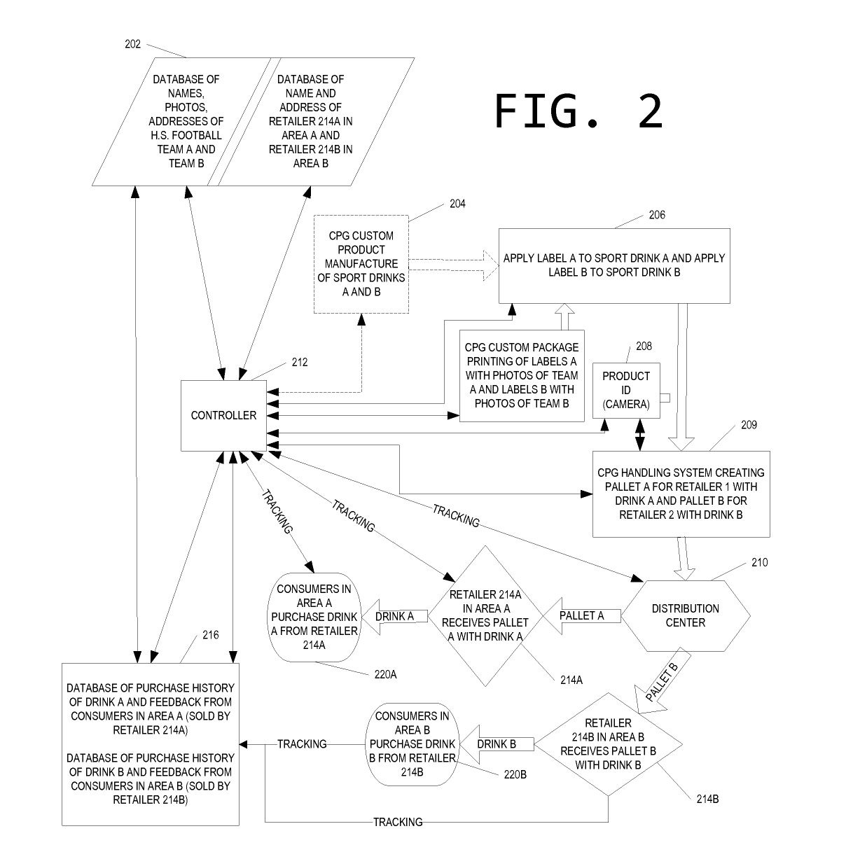

### FIG. 2—An Example of One Embodiment

FIG. 2 is a block diagram of one embodiment of a system and method of the invention for the manufacture, distribution and tracking of a custom sports drink with custom marks based on local teams and retailer information and based on previous purchase history of the sports drink.

In FIG. 2, a system 200 includes a database 202 of information regarding a first demographic group A in a first area A and a second demographic group B in a second area B. In particular, database 202 includes the names, photos and addresses of high school football team A and team B. The database 202 also includes a listing of first retailers 214A in the first area and second retailers 214B in the second area. In particular, first retailers 214A are located in an area where team A plays and second retailers 214B are located in an area where team B plays.

The system 200 also includes a supply system 204 for supplying a first product according to information in the database regarding the first demographic group and for supplying a second product according to information in the database regarding the second demographic group. In particular, supply system 204 supplies sports drink A which targets team A and supplies sports drink B targeting team B. A marking system 206 applies a first mark to the first products and applies a second mark to the second products. The first mark includes information from the database regarding the first demographic group and the second mark includes information from the database regarding the second demographic group. In particular, marking system 206 applies photos of team A to the first products and applies photos of team B to the second products. As noted above, the photos come from the database 202 and are organized by demographic and/or geographic information (e.g., team A in area A and team B in area B).

An identification system 208 identifies the first and second products. In particular, sport drink A is identified and tracked and sports drink B is identified and tracked. Each individual drink container may carry a unique code to identify it. Alternatively, the custom printing on each individual package could be scanned and evaluated. For example, the identification system 208 may include image recognition software which could be matched against the database 202. Since the pictures of team A are on sports drink A and since pictures of team B are on sports drink B, identifying the picture on each individual drink package indicates whether it drink A or drink B.

A CPG handling system 209 via a distribution center 210 distributes the identified first products to the first retailers in the first area and distributes the second products to the second retailers in the second area. A controller linked to the database 202 and the identification system 208 provides information to and controls the operation of the supplying system 204, the marking system 206 and the distribution center 210. In particular, the distribution center 210 separates and routes drink A onto pallet A for shipping to retailer 214A in area A where team A plays. Consumers 220A in area A are then able to purchase drink A with has been targeted to area A and the drink A includes pictures of their local football team A. Similarly, the distribution center 210 separates and routes drink B onto pallet B for shipping to retailer 214B in area B where team B plays. Consumers 220B in area B are then able to purchase drink B with has been targeted to area B and the drink B includes pictures of their football team B.

As noted above, the database 202 may include a database 216 of purchase history of drink A and feedback from consumers in area A sold by retailer 214A. This information allows the drinks A and B to be distributed in the future based on the feedback information. For example, if sales are increasing in area A and decreasing in area B, more of drink A could be manufactured and delivered to area A and less of drink B to area B.

### Route Sequenced Customized Pallet

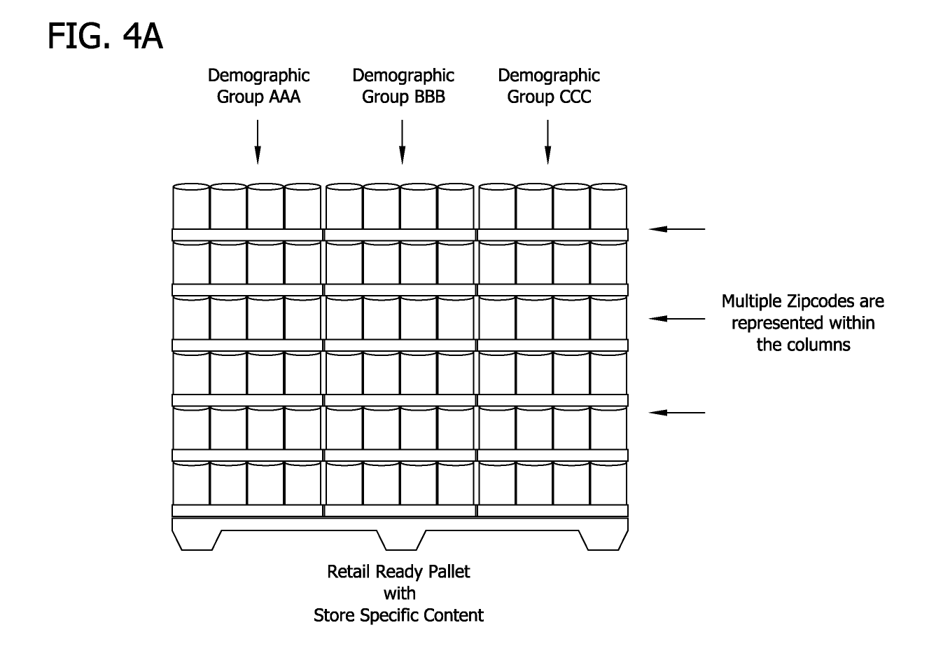

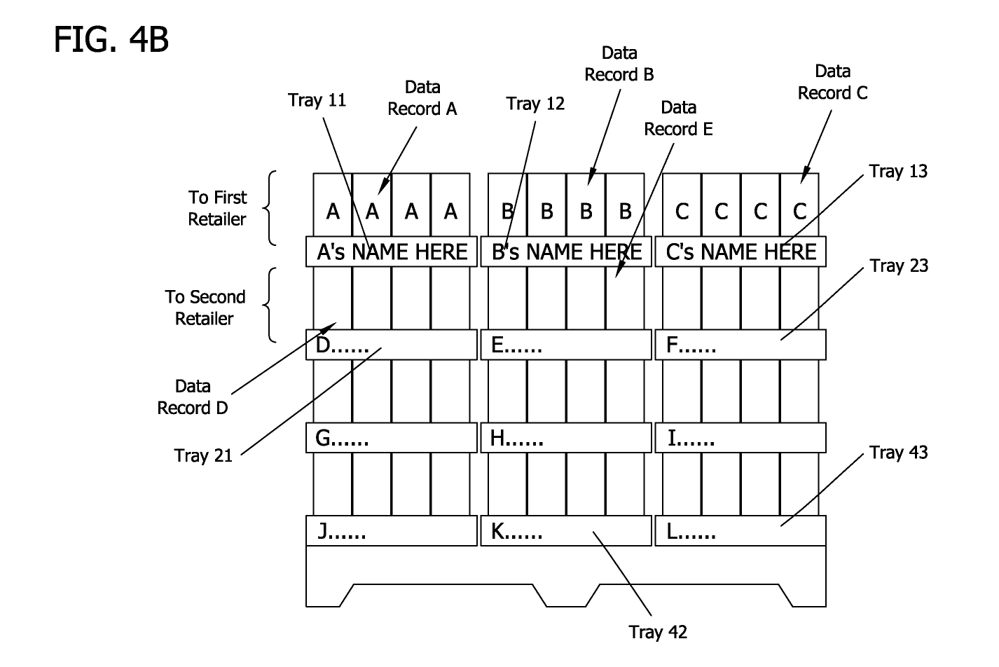

As shown in FIGS. 4A and 4B, the distribution of the products may be controlled at a pallet level. FIG. 4A is an illustration of one embodiment of a route sequenced, customized pallet according to the invention.

In this embodiment, the boxes are manufactured to correspond to the carrier which is specific to a specific demographic group (school in this embodiment). The cases are grouped vertically to correspond to a second demographic (school district). Multiple school districts are combined based upon demographics into a single pallet built for a specific retail outlet. The demographic/geographic profile of the retail outlet determines the schools and school districts that will be represented on the pallet.

The above components of the system are coordinated and controlled by a controller 112 linked to the database 102, and linked to the identification system 108 for controlling the operation of the product supply system 104, the marking system 106 and the distribution center 110.

Thus, in one embodiment, the invention comprises a system and method, such as illustrated in FIGS. 1-3 for producing a store specific pallet in route sequence as illustrated in FIG. 4A. In particular, as shown in FIG. 1, the database 102 contains multiple files needed for producing RRPP. Zip codes may be used to designate specific geographical areas for this embodiment but other geographical designations are envisioned. Demographic/Psychographic coded customer databases (AAA, BBB, CCC, for illustration) contain geographic zip-code designations as well as personal information 102A. Retail outlets are associated with the zip-code areas that the retail outlets primarily serve 102B. Further, retail outlets are grouped by route and indexed by delivery order 102C. To create a run sequence file, the quantity of product for each retail unit, and the demographic group(s) which are to be targeted for each specific retail unit are used in conjunction with the database to produce a specific run sequence that delivers product grouped at the retail level containing the demographic groups selected within the retail units zip-codes that it serves. Further, the sequences in which the retail unit groupings are produced are in order relative to delivery route. For example, in one embodiment the invention comprises a system and method, such as illustrated in FIG. 1 for producing a store specific pallet in route sequence as illustrated in FIG. 4A or 4B.

In particular, as shown in FIG. 1, the database 102 provides information regarding the demographic groups and quantity for each retail destination. For illustration retailer A requires 5000 units of product and serves 53168, 53179, 53104, 53105 and 53139. The promotion for the product is tailored for three specific demographic groups (AAA, BBB, CCC). The system will scan the database of demographic groups and build a run file for that retail unit that includes only the intersection of specified database elements. In the event that the quantity of product needed is greater than the intersection of the selected variables, items may be duplicated. As FIG. 1 illustrates, database 102 contains elements of customer information 102A (demographic information), Retailer Information 102B (demand and location), and delivery route information 102C. The controller 112 uses these elements to create a specific product production list. As production is started products having custom variable images and data 104 are printed to the standard packages 105. Where downstream processes are not linearly tracked (asynchronous to the print), an extra code is added to the product such as a barcode so that it may be specifically identified later in the process. As packages are printed the print verify function 115 is executed which assures that the controller 112 can correctly associate the proper database information to a specific product/package. The custom printed packages are combined with the products 106. The printing of the package may occur before or after the product has been combined with the package. Product is tracked through the machine to the handling process where it is grouped and packed for distribution. Product tracking may not always be possible using linear motion tracking. When this is the case, products are identified at critical sortation points along the process utilizing a product ID reader (typically a camera). As product is tracked through the CPG handling 109, the processes is controlled so that product is grouped/stacked/palletized based upon the database/retail/route information such that each final bulk unit (pallet) is retail unit specific with specific content based on the local demographic profile.

Thus, in another embodiment, the invention comprises a system and method, such as illustrated in FIGS. 1-3 for producing a route sequence pallet as illustrated in FIG. 4B. For example, the top tier may include product A within tray 11 and product B within tray 12. Trays 11 and 12 including products A and B would be delivered to a first retailer. Similarly, the second tier may include product C within tray 12 and product D within tray 23. Trays 12 and 23 including products C and D would be delivered to a second, different retailer. Tray 11 could have products printed with custom graphics A and the tray could be printed with the same or related graphics. Similarly, tray 12 could have products printed with custom graphics B and the tray could be printed with the same or related graphics.

In particular, as shown in FIG. 2, the database 202 provides information regarding the first demographic group A in the first area A, the second demographic group B in the second area B, the first retailers 214A in the first area A and the second retailers 214B in the second area B. The marking system 206 applies the first mark (label A) to the products wherein the first mark targets the first demographic group A in the first area A. The marking system also applies the second mark (label B) to the products wherein the second mark targets the second demographic group B in the second area B. The identification system (camera 208) identifies the first products (drink A) having the first mark (label A) and identifies the second products (drink B) having the second mark (label B). The distribution system 210 distributes the identified first products (drink A) to the first retailers 214A in the first area A and distributes the second products (drink B) to the second retailers B in the second area B. The controller 212 is linked to the database 202 and is responsive to the identification system 208 for controlling the operation of the marking system 206 and the distribution system 210. As shown in FIG. 4B, drink A would be positioned on the top tier for delivery to the first retailer 214A and drink B would be positioned on the second tier for delivery to the second retailer 214B. Retailer 214A would get the first delivery of the top tier followed by retailer 214B getting the next delivery of the second tier. As a result, the pallet of FIG. 4B comprises a route sequenced, customized pallet, customized for sequential delivery to retailer 214A and then to retailer 214B. This results in a destination specific customized product package uniquely positioned on the route sequenced, customized pallet.

It is also contemplated that only certain parts of a tray would have drink A for delivery to retailer 214A. It is also contemplated that a tray may include both drinks A and B for delivery to a retailer. For example, if a retailer sells more of drink A than drink B, a tray could be configured to have more of drink A (e.g., a tray of 16 could have 10 of drink A and 6 of drink B).

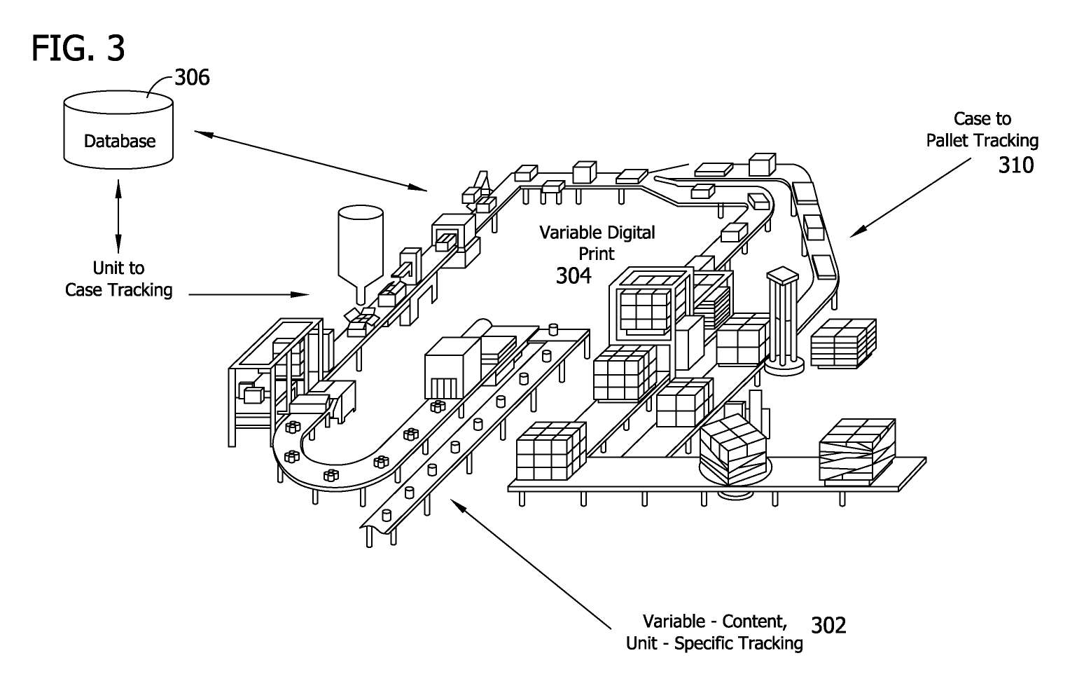

### FIG. 3

FIG. 3 is a perspective view of one embodiment of a product line according to the invention. At 302, products are supplied to the line having variable content with markings that permit unit-specific tracking, as noted herein. At 304, two variable digital print stations print information such as tracking marks and/or demographic specific information on the products (or labels for the products), each product having a unit-specific marking. The database 306 is linked to the system to provide unit to case tracking of each unit of product and to provide the demographic information. Finally, the distribution system 310 provides case to pallet tracking of each individual unit.

The route sequenced, customized pallet may be configured with tiers and/or trays (carriers) that are designated for delivery at different locations. The pallets are loaded in reverse order to permit sequential delivery without the need to re-assemble or reorganize the pallet after each delivery.

### Optional Feature: Print Verify

Historically, variable print applications within CPG processes relate to time, lot or batch and are not product specific on an individual piece by piece basis. Essential to the implementation of certain embodiments of the invention is an assurance that the specific information on each piece be correct on a piece by piece basis. Variable inkjet printing is not by itself reliably deterministic that a given message/image/data will be printed on the piece the control system has sent the data for. An optional but important aspect of embodiments of the invention is a print verification system 118 and/or process. For example, an inkjet printer may be monitored by the print verify system 118 for several signals and protocol elements. It is the combined monitoring of these signals which provides the assurance and confirmation from the print verify system 118 to the controller 112 that the expected print is on the expected product. If the processing of a given piece is in error, corrective action is taken based upon the type of error and machine parameters.

### Option Feature: Reorder and Re-sequencing

Historically, variable print applications within CPG processes relate to time, lot or batch and are not product specific on an individual piece by piece basis the result of this is that an improperly printed message or damaged product is of no consequence to the manufacturing process. An optional but important implementation of embodiments of the invention includes the methodology and system within the controller 112 which not only identifies bad, damaged, or missing product but which allows for that specific product to be re-entered (reordered) into the manufacturing process. This assures that all products are completed. Products that are reordered may not be able to be put back into the original sequence position. For example, the system 101 may have algorithms that allow it to handle this situation in the most efficient way possible which may include separate processing of the reorder, diverting it for alternate handling or delaying the reorder to be batched with other reorders. Control algorithms within the system 101 make adjustments for the missing process for subsequent processes such as stacking and palletization devices.

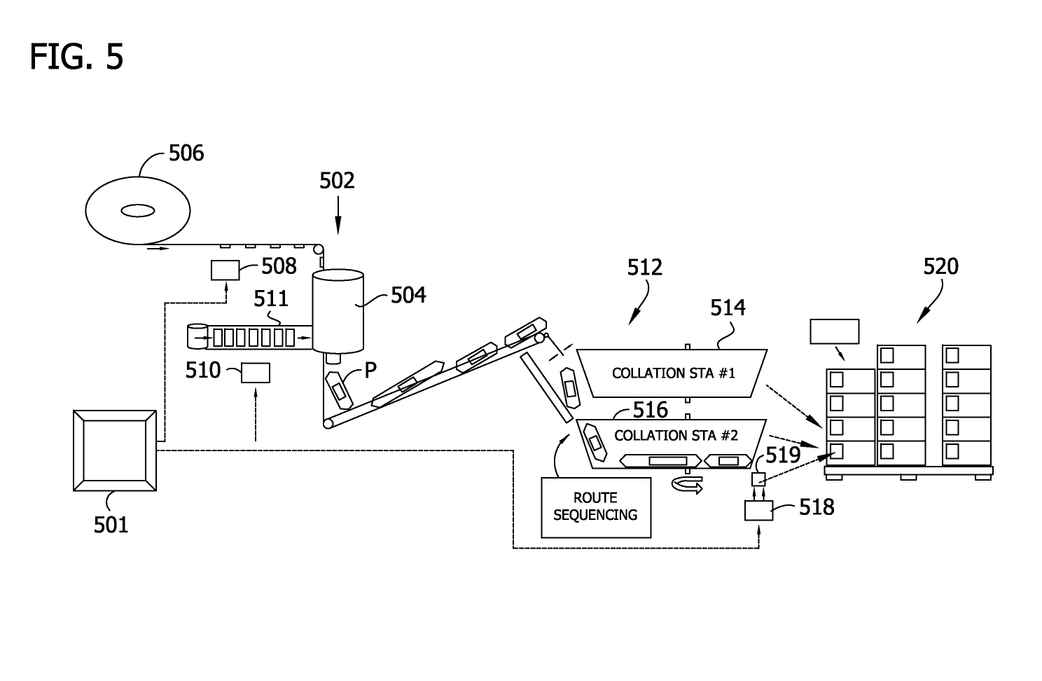

### FIG. 5—Convenience Store Illustration

FIG. 5 is an illustration of one embodiment of the invention within a packaging line providing products with a private label gaming and targeted promotion initiative for a convenience store. FIG. 5 embodies one possible implementation of an embodiment with applied scratch-off layer printed on a package. Other implementations may be phased or partially implemented. Custom content may be added at any one or more of three locations.

Although illustrated as part of a form, fill and seal process, any manufactured product or process 502/504 may be substituted according to the system and method as illustrated in FIG. 5. The system is controlled by an imaging package line controller 501 which interfaces with the a database or existing manufacturing execution system (MES) planning system. Such MES systems typically comprise a manufacturing tool designed and built for manufacturing. Most manufacturing companies use a planning process to determine what products are to be manufactured. Once that plan has been developed, there must be a translation of the plan that deals with real resources that are currently available. What is necessary is a method and system to take input from the planning system and translate that plan into a language that fits the plant floor and the resources required to execute the plan—a major role for the MES. Interfacing the packaging and imaging control 501 with MES is an aspect of the database interface. The quantity of product to be made, status information and raw material information may all be associated with the products created by the packaging and imaging control system. This provides a mechanism where individual products may be tracked back to not only the time and manufacturing or packaging line from which it was produced, but also the raw materials used and other variables that part of that process.

Product from a core manufacturing process 502 (e.g., corn chips supplied by a batching process) are supplied to a packaging machine such as a form, fill, seal and label machine 504 which creates individual packages P from a packaging roll 506 of a web of sequential packages. In phase 1, a printer 508 prints an individual, unique promotional code or other promotional feature on each, sequential individual package of the continuous web of sequential packages which is formed by the form, fill and seal machine into individual products. The code or feature may be covered by a scratch-off layer. At Custom Content Location #2, a high resolution variable imaging printer 510 prints onto a peel off label applied at 511 with unique, variable printed information which is applied to each unique, individual package.

Next is the area where delivery route and/or store sequenced layering and palletization is implemented. A conveyor transports each unique, individual package to an existing pallet stacking system 512 (e.g., a versioning and package flow separator which diverts products to particular stations). Optionally, in Route Sequencing (custom content location #3), collation stations #1, #2 (e.g., a routing bin or turntable) 514, 516 will create delivery route store-sequenced pallets 520 wherein each layer is slated for delivery to a particular retailer. In general, route sequencing includes route and store sequenced cartoning and palletization with targeted custom content. An identification system identifies each unique package so the routing bin/turntable 514 knows where to place each unique package within the stack of the pallet. In one embodiment, the identification system includes a variable image carton label printer 518, with embedded pallet position and/or delivery route detail, which prints or embeds a pallet position label 519 on each unique package in accordance with a delivery route detail. Communication between the various components may be via a wired or wireless high-speed Ethernet network or a Profibus™ communication backbone network.

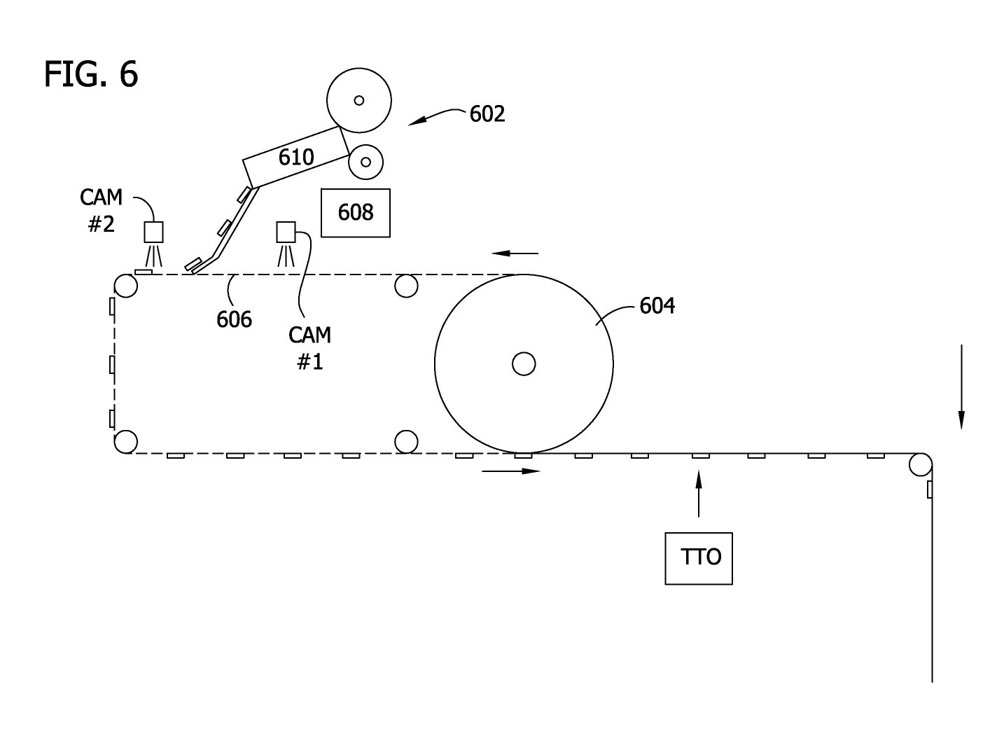

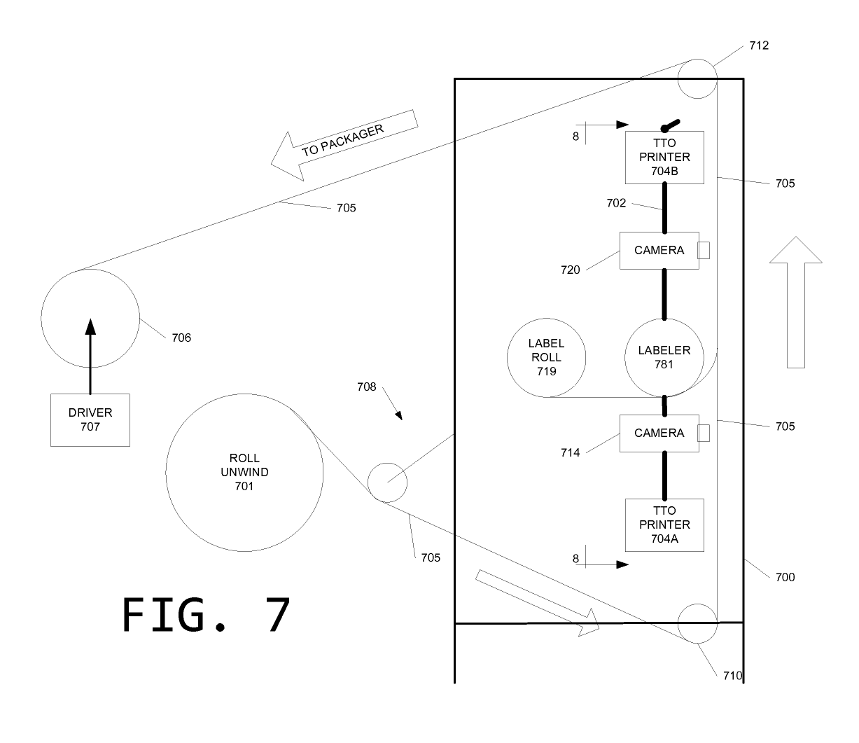

### Mobile Personalization Module Embodiment FIGS. 6-13

FIG. 6 is an illustration of one embodiment of the invention added to an existing packaging line, such as a form, fill and seal machine. In this embodiment, a mobile personalization module (MPM) 602 is added to the existing packaging line to add a private label, gaming and/or targeted promotion or other initiative to the packaging of products as the products are being manufactured. In particular, FIG. 6 illustrates an embodiment with an applied thermal transfer overprinting (TTO) layer applied to packaging (and/or labels) on the fly as the packaging is being prepared to receive products. Alternatively, the MPM may be positioned after a product is packaged to mark the packages of the product.

The existing packaging system as shown in FIG. 6 includes a packaging roll unwind 604 which will provide a plastic film such as Mylar® to be formed into a bag or to be used as some other package. The typical machine is loaded with a continuous flat roll of a web of plastic film, which will have labeling and artwork applied to the exterior or interior of the film. Note that while plastic is the most commonly used packaging material in the food industry, the technology can also be used to form continuous paper and fabric product containers by changing the edge sealing/seaming methods. In general, almost every type of packaging allows printing and/or adding unique identification marks as noted herein.

For a form, fill and seal machine, after printing by an existing TTO layer application device, the film approaches the back of a long hollow conical tube, and when the center of the plastic is near the tube, the outer edges of the film form flaps that wrap around the conical tube. The film is pulled downward around the outside of the tube and a vertical heat-sealing bar clamps onto the edges of the film, bonding the film by melting the seam edges together.

To start the bagging process, a horizontal sealing bar clamps across the bottom edge of the tube, bonding the film together, and cutting off any film below. The sealed tube end is then lowered onto a precision weighing table and the product to be bagged is dispensed through the long conical tube in the center of the bag.

When the gross weight of the product-filled bag is reached, filling stops, and the horizontal sealing bar seals the top of the bag, and simultaneously forms the bottom of the next bag above. This bag is then cut off from the tube and is now a sealed package, ready to advance onward into the product boxing and shipping processes.

During the final sealing process, the bag may be filled with air from a blower or from an inert gas supply. Inflating the bag helps reduce the crushing of fragile products such as potato chips, while inflating with an inert gas helps drive out oxygen and retards the growth of bacteria that would spoil the product.

In one form, the invention is a portable, modular, self-standing unit (herein a MPM or mobile personalization module) MPM 602 that can be temporarily or permanently located between the existing packaging roll unwind and the bagging process. Generally, but not necessarily, the MPM 602 would be positioned along a film 606 being unwound from the packaging roll unwind 604 after printing of the film but before forming of the film into a package. The MPM 602 may include a database of information regarding various demographic groups in various neighborhoods, and also includes information regarding various retailers in various neighborhoods. The database may be resident within the MPM 602 or it may be remote from the MPM, accessible by the MPM via a wired or wireless network. The MPM 602 also includes a marking system for applying unique, individualized marks such as 2-D bar codes to at least some of the sections of the film that will be formed into a package. Individualized marks are applied to target demographics group, to target consumers of each retailer and/or to target neighborhoods. The MPM 602 would include one or more cameras or readers for reading the printing on the packaging and/or for reading the marks.

Coordination between the MPM 602 and a controller of the packaging machine (e.g., the form, fill and seal machine) can be accomplished is various ways. In one embodiment, the MPM 602 and the packaging machine may run independent of each other. In another embodiment, the MPM 602 may control the rate at which the web proceeds through the packaging machine so that the MPM 602 has auxiliary control of the packaging machine or other OEM equipment resulting in the printing, labeling and packaging being coordinated. In another embodiment, the packaging machine may control the rate at which the web proceeds through the MPM 602. Any of these embodiments may require a buffer or intermediate control between the MPM and the packaging machine.

For example, the MPM illustrated in FIG. 6 includes a TTO Promo Print-On-Pack device 608 positioned along the film followed by camera #1, followed by a Scratch Off Layer (SOL) Device 610 for applying SOLs followed by camera #2. In this configuration, the TTO Promo Print-On-Pack device 608 would include the database or means for accessing the database. The TTO Promo Print-On-Pack device 608 would provide information to the Scratch Off Layer Device 610 regarding the specific 2-D marking to apply to a particular section of film. The specific marking would be associated with a specific demographic or retailer or neighborhood.

Camera #1 would continuously read the position of the film and provide the position information to the Scratch Off Layer Device 610 and would activate the device when a mark should be printed. Camera #1 could read registration marks on the film or it could be looking for a particular graphic printed on the film in order to orient the location of the film relative to the Scratch Off Layer Device. Optional camera #2 is positioned after the TTO layer and scratch off layer are applied to the film 606 by the Scratch Off Layer Device 610. Camera #2 verifies the mark and could look to verify that the applied mark is in the right location, that the mark is readable, and that the mark includes the proper information. Camera #2 is connected to an archive which cross references the mark and thus the particular package to the demographic, retailer or neighborhood being targeted.

The mark applied to the film 606 may involve gaming or couponing or other promotions. Preferably, the mark it related to a program of target marketing and/or cross branding. One purpose of the program may be to provide shopper loyalty and insight into a shopper's buying preferences. Because each mark is unique (or each group of marks may be unique), the MPM 602 facilitates versioning by neighborhood and tracking of each product. Although the above indicates the mark as a TTO layer, the mark may be any unique indicator, such as a serial number, a variable QR code or a simple or complex bar code.

Individual products may be tracked as noted herein. For example, the product can be tracked at the point of sale or it can be tracked when a consumer responds to the TTO layer or when the consumer otherwise takes advantage of the promotion related to the TTO layer. This tracking information is matched to the original archived record of the mark to provide feedback and additional information regarding demographics, neighborhoods, retailers and/or preferences to further define and modify the program being implemented. In this way, future packaging can be more or less specifically targeted depending on the feedback and the program involved.

The MPM 602 may be on wheels, on a palette or otherwise movable and positionable along the film. In one embodiment, the MPM 602 is configured for use with various types of films and packaging systems so that it can be moved from one packaging line to another line to mark products. It is also contemplated that the MPM 602 may be configured for a specific line and used intermittently with the line. In this configuration, the MPM would be selectively moved into position to mark selected products runs made on the specific line.

FIG. 7 illustrates a stand-alone mobile personalization module (MPM) 700 for use in conjunction with a typical roll 701 of product packaging material (PPM) packages. MPM 700 may be an add-on feature to an existing manufacturing process line, giving added value, intelligence, additional utility and functionality to the line without the need to modify the line. The module 700 comprises the next generation retail ready personalized packaging (RRPP) module, also referred to as an “on pack mobile personalization module.” The module 700 includes an adjustable frame assembly 702 for positioning one or two or more “Communicator II” thermal transfer overprinting devices 704, or some other printer, along a web 705 provided by the roll 701. After printing and layering, the web 705 may be provided to a typical bagger unit (not shown) or it may be provided to a rewind roll 706 having a driver 707, such as a motor, for revolving the rewind roll 706 to pull the web 705 through the module 700 and to take up the web after printing and layering.

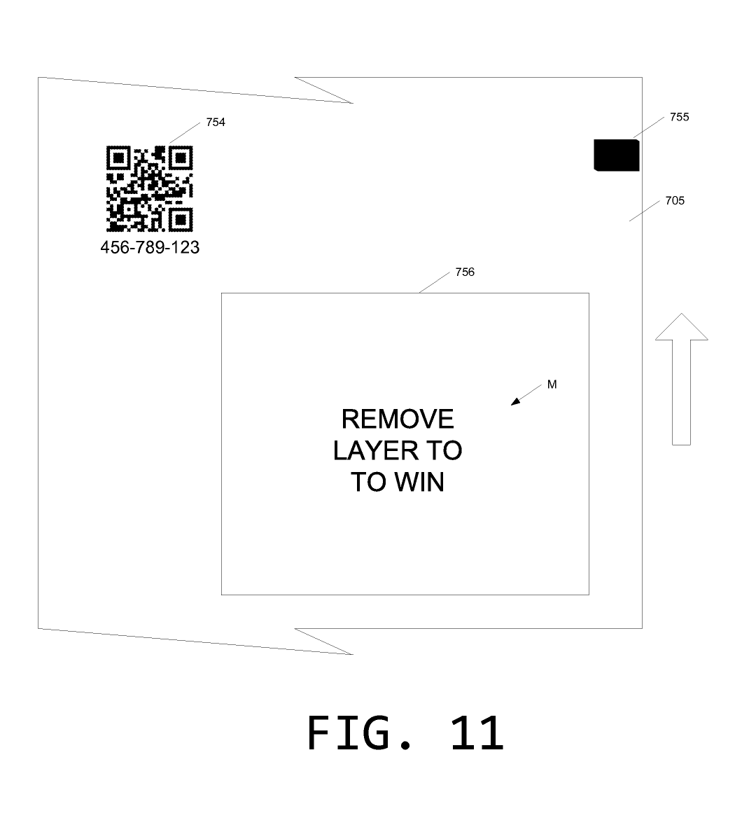

The web 705 unwinds from roll 701 and passes through an adjustable film feed guide 708. The web is supported by rollers 710, 712 and the TTO printers 704 are positioned by the subassembly 702 between the rollers. Additional rollers (not shown) may be used to support the web. Adjacent the lower TTO printer 704A is a first camera 714 for reading the web position as the web 705 moves past the TTO printer 704A and first camera 704. The camera 714 may read a graphic, a mark printed by TTO printer 704 A and/or an index mark on the web to track web position. Based on the information provided by the first camera 704 to a processor of a controller module (see FIG. 11), an ST 1010 label applicator 718 or some other layering device is energized to selectively apply scratch off labels supplied by a label roll 719 to the web 705 at appropriate positions on the web, essentially one label of each successive package unit along the web.

A second, optional camera 720 along the web 705 after the label applicator 718 reads the scratch off label to confirm that it has been properly positioned at the correct location on a package of the web 705.

The web is fed over the rollers 712 to a packager or bagger (not shown) or to the rewind roll 706 for use by a packager or bagger, such as a form, fill, and seal machine, and for distribution.

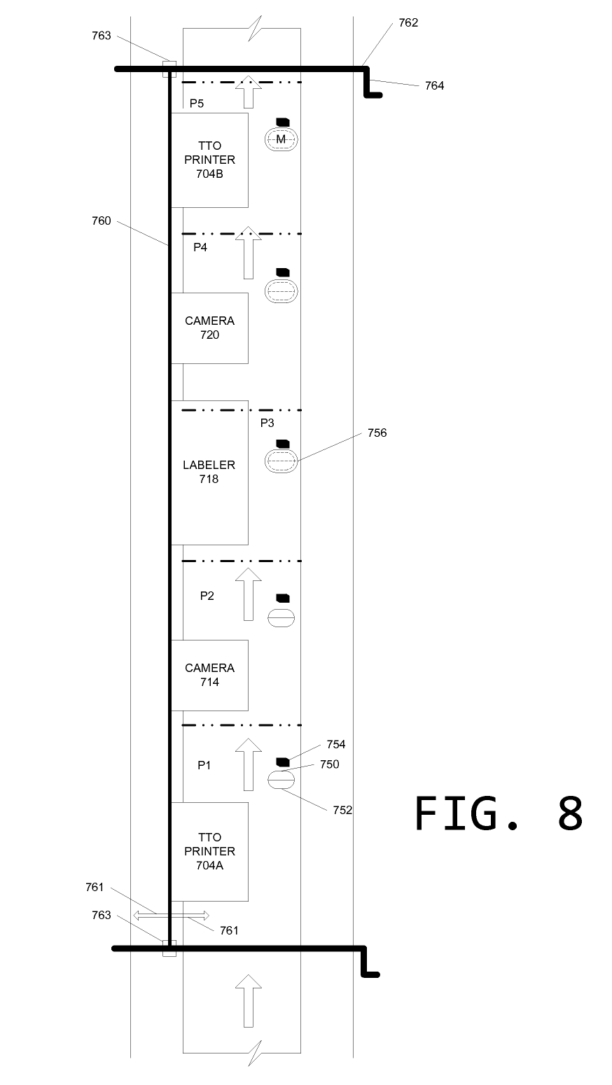

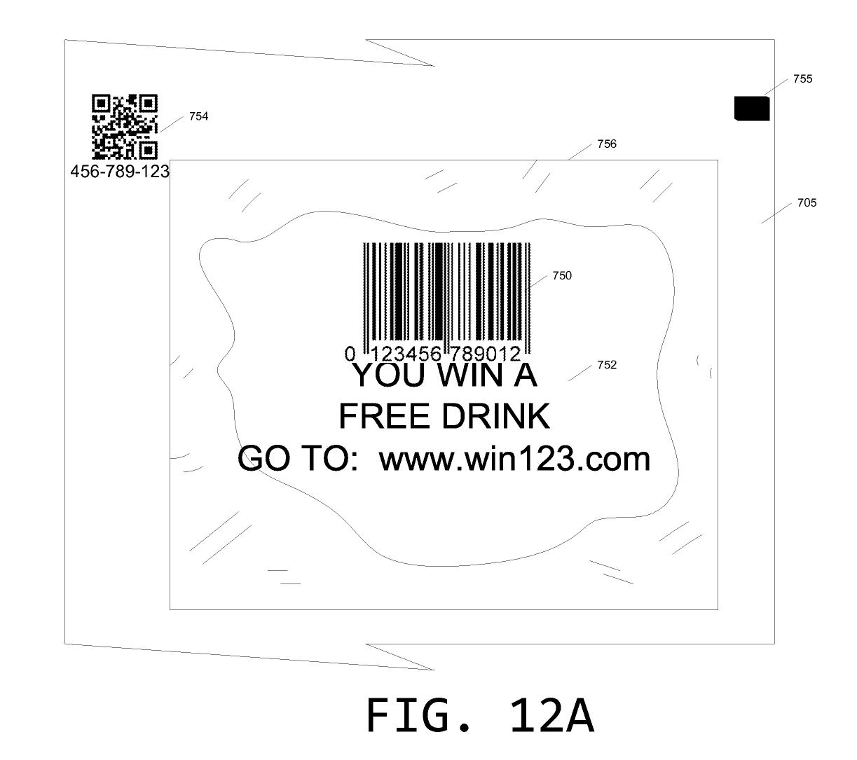

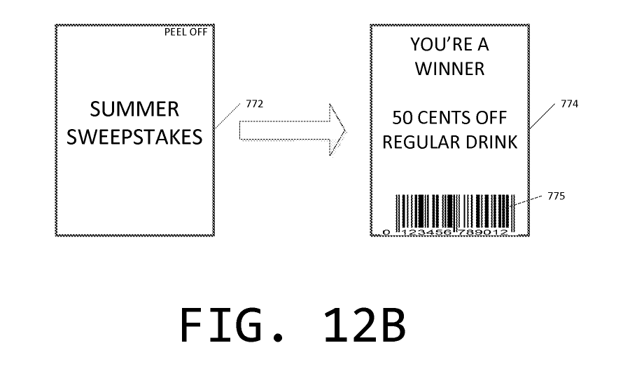

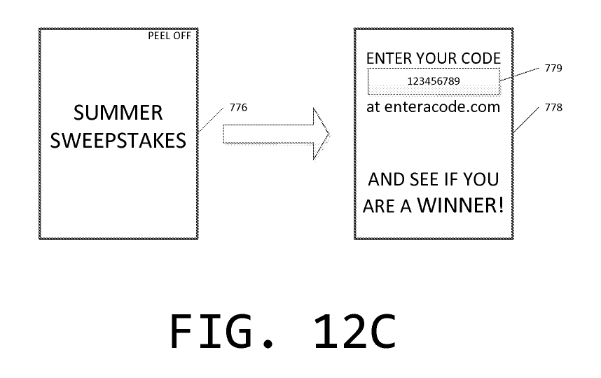

FIG. 8 is a view of the stand-alone module of FIG. 7 taken along lines 8-8 of FIG. 7. The web 705 is a continuous, sequential series of packages P1-P5. As the web progresses upward as indicated by the arrows and as each package progresses through module 700, the lower TTO printer 704A applies a first promotion code image 750 and a first promotion image 752 to the package P1 and to the web 705. Optionally, a first ID code image 754 may also be applied. The first ID code image 754 may be a 2-dimensional UPC or QR code used for tracking the particular package and, optionally, as a registration mark 755. The first promotion code image 750 and a first promotion image 752 may be a UPC code along with text image such as “YOU WIN A FREE DRINK” (described below in more detail with regard to FIGS. 11 and 12). As the web 705 moves upward, camera 714 (and/or camera 720) monitors the position of the packages of the web 705 relative to the TTO printers 704 and labeler 718. For example, the camera 714 may read a graphic on package P1, and/or it may read the images 750, 752, 754 to determine the position of package P1 relative to the camera 714 and relative to the TTO printers 704 and to confirm the position of images 750, 752, 754. Alternatively, a photoeye or other reading device may be used in place of either or both cameras.

Next, labeler 718 applies a scratch off layer or label 756 over the first promotion code image 750 and/or the first promotion image 752 to hide one or both. Next, camera 720 may read a graphic on package P1, and/or it may read the images 750, 752, 754 to determine the position of package P1 relative to the camera 714 and relative to the TTO printers 704 and to confirm the position of the scratch off label 756. Either camera 714 or 720 is optional as one camera may be employed to track web, image and label positions. Alternatively, if some other time of registration system is used to determine web positions, both cameras may be optional as the image and label positions do not need to be confirmed. Next, an optional upper TTO printer 704B applies a message M on the scratch off label 756. The upper TTO printer 704B is optional. For example, the labels 756 may be pre-printed with a message on them, a message may be printed on the packaging or no message is may be used. Alternatively, the labels may be printed before application to the web 705. For example, printer 704B may be supported by an adapter plate (not shown) attached to the labeler 718 and print on the label while it's on the label roll in the labeler 718 before the label is applied to the web 705.

FIG. 8 also illustrates one embodiment of the subassembly 702 in the form of a vertical support member 760 which supports TTO printer 704A, camera 714, labeler 718, camera 720 and TTO printer 704B. The position of the TTO printer 704A, camera 714, labeler 718, camera 720 and TTO printer 704B each may be moved or adjusted vertically relative to member 760 so that their relative positions may be adjusted, depending on the packaging spacing and other image location factors. The vertical support member 760 is held in place by upper and lower horizontal members 762 which engage a frame 764. The vertical support member 760 moves horizontally relative to the upper and lower horizontal members 762 so that the TTO printer 704A, camera 714, labeler 718, camera 720 and TTO printer 704B move in unison to the right or left to position them laterally relative to the width of the web. In one embodiment, the horizontal members 762 comprise a threaded shaft engaging a nut 763 on vertical support member 760. By rotating the members 762 such as by cranking handles 766 (or by activating motors) the vertical member 760 is moved laterally left to right, or vice versa. As a result, cranking the handles 766 simultaneously moves TTO printer 704A, camera 714, labeler 718, camera 720 and TTO printer 704B left to right, or vice versa to position them relative to the width of the web. As a result, the cameras can be properly positioned to read the graphics or other indexing marks on the web and the printers and labeler can be positioned to print and label the appropriate locations on the web.

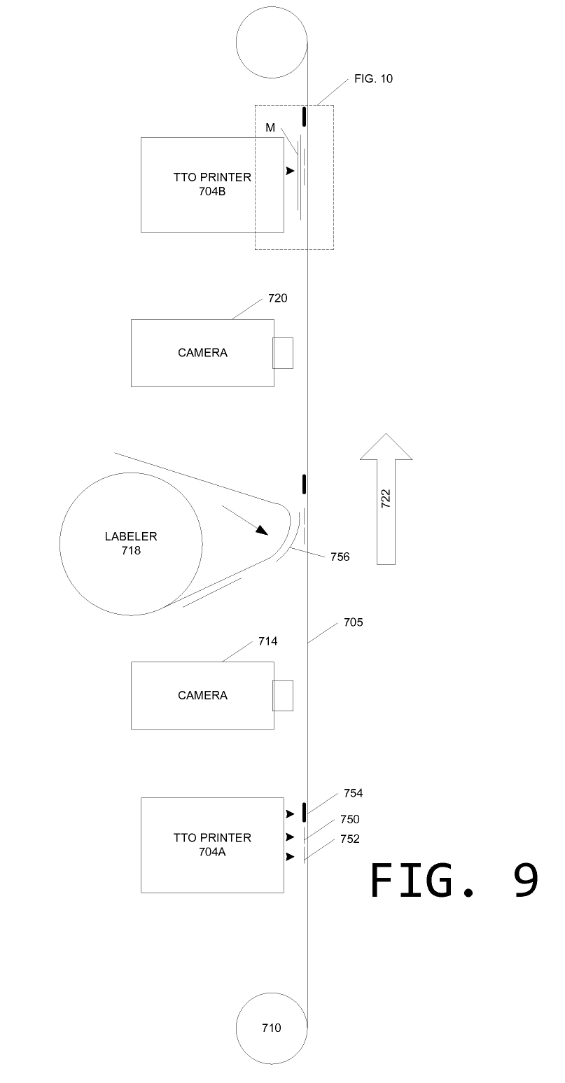

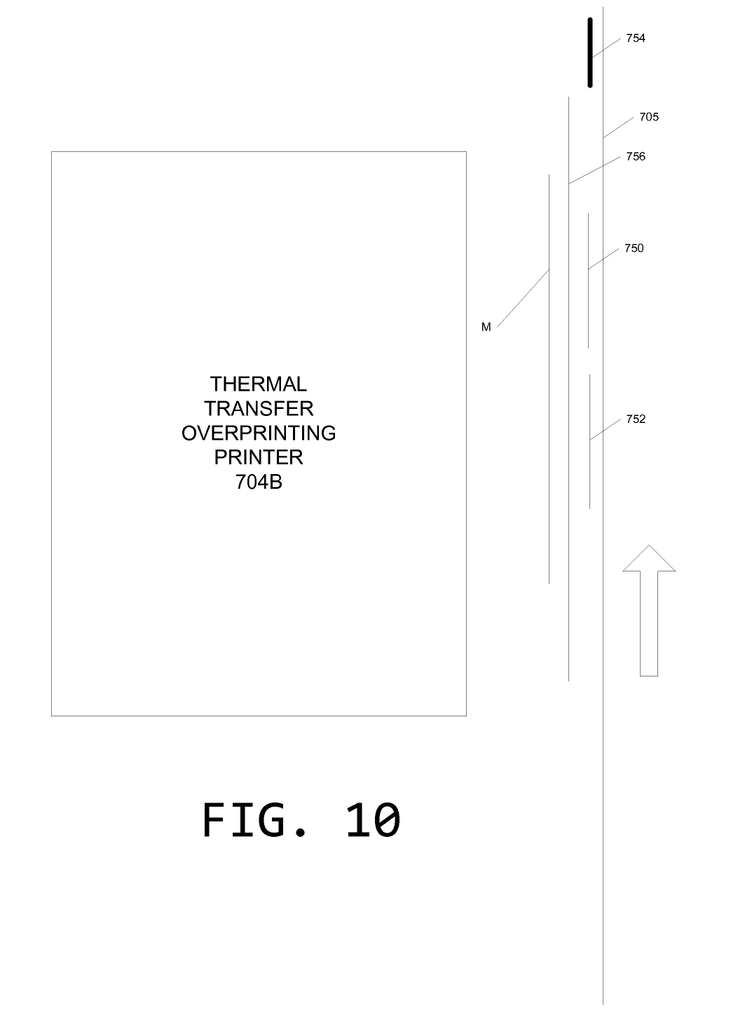

FIGS. 9-10 further illustrate the elements (e.g., printing, layers, labels) applied to the web by the module 700. FIG. 9 is a partial, exploded side view of the stand-alone module 700 of FIG. 7, illustrating the various elements of printing and labels applied to the web 705. FIG. 10 is an exploded, partial side view of the thermal transfer overprinting (TTO) printer 704B and the web 705 of PPM package after the images and scratch layer have been applied.

As the web 705 is pulled upward (arrow 722) by the rewind roll 706, five different elements are applied to each package, although some of these elements are optional. As the web progresses upward and as each package progresses through module 700, the lower TTO printer 704A applies the first promotion code image 750 and the first promotion image 752 to the web 705 on the fly. The optional first ID code image 754 is also be applied. As the web 705 moves upward, camera 714 (and/or camera 720) monitors the position of the packages of the web 705 relative to the TTO printers 704 and labeler 718. Next, as the web moves up, labeler 718 applies a scratch off layer or label 756 over the first promotion code image 750 and/or over the first promotion image 752 to hide them both. Next, camera 720 may read a graphic on package P1, and/or it may read the images 750, 752, 754 to determine the position of package P1 relative to the camera 714 and relative to the TTO printers 704 and to confirm the position of the scratch off label 756. Next, the upper TTO printer 704B applies a message M on the scratch off label 756 on the fly.

FIG. 11 is a plan view of an image on a web, according to one embodiment of the invention. All five elements have been applied to the web but only the scratch off label 756, message M on the scratch label and the first ID code image are visible. FIG. 12A is a plan view of the image of FIG. 12A. A portion of the scratch layer 756 within area 757 carrying the message M has been removed, so that FIG. 12A illustrates the first promotion code image 750 and the first promotion image 752. FIG. 12A also illustrates an optional registration mark 755. The size, position, content and/or other features of these elements may vary.

FIGS. 12B and 12C are a plan view of an instant win version and a non-instant win version of FIG. 12A. In this embodiment, certain products are marked and tracked to include an instant win indication as illustrated in FIG. 12B. A scratch off layer 772 covers a coupon 774 including a code 775 which when scanned provides the bearer with a benefit, in this example 50 cents off a regular drink. In this embodiment, certain other products are marked and tracked to include a non-instant win indication as illustrated in FIG. 12C. A scratch off layer 776 covers a coupon 778 including a code 779 which when entered at a website (e.g., enteracode.com) may provide the bearer with a benefit. After the bearer enters the code 779 at the website, the bearer may be provided with a coupon or other benefit and/or the bearer may be provided with a questionnaire which elicits information from the bearer to assist in providing demographic or preference information useful for offering future products, services and/or promotions. In addition, the information provided by the bearer may allow detailed tracking of the individual product from manufacture to purchase to the end user. A unique, additional tracking code (not shown) may be added to each product or package for tracking and/or identification purposes.

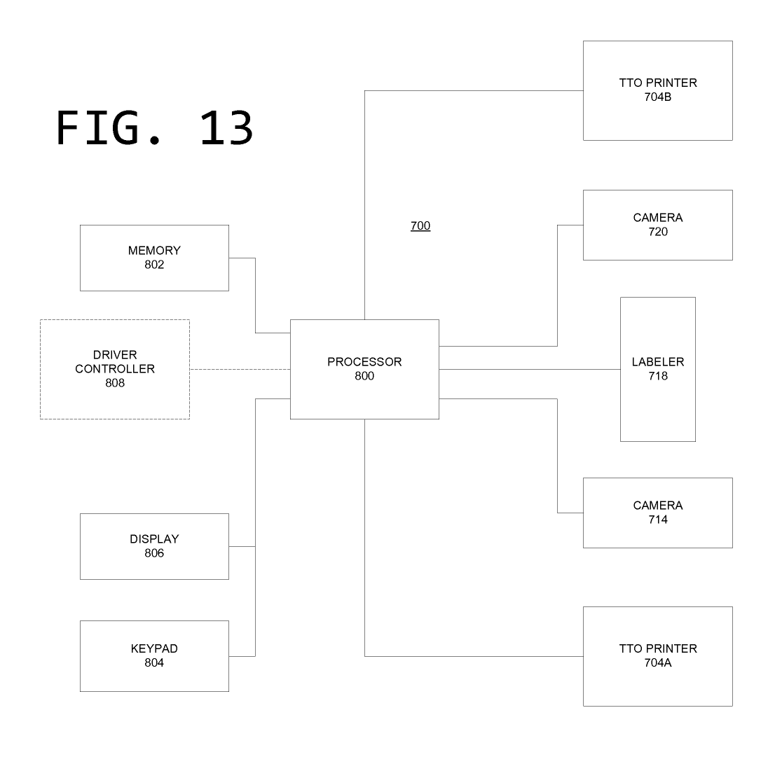

FIG. 13 is a block diagram of the stand-alone module 700 of FIG. 7, according to one embodiment of the invention in which a processor 800 controls and coordinates operation of the various components. The processor 800 accesses a database or memory 802 including data files (records) of information including codes and messages to be applied to a web. An operator uses a keypad 804 and display 806 to input and view various parameters of the module 700. The processor 800 may be connected to a driver controller 808 which controls the driver 707 driving the rewind roll 706, although the driver 707 may operate independently of the processor 800. Driver controller 808 is shown in phantom as it is an optional part of the module 700. Since the cameras 714, 720 are monitoring web and image location, the processor 800 does not necessarily need to control the driver 707.

In one embodiment, the driver 707 is set to drive the rewind roll 707 at a constant speed and the processor 800 turns the driver on and off. In response to the sensed position of the web 705 as indicated to the processor 800 by either or both cameras 714, 720, the processor 800 instructs the lower TTO printer 704A to print the first promotion code image 750, the first promotion image 752 and the first ID code image 754 on the web 705 at the appropriate location. Also, in response to the sensed position of the web 705 as indicated to the processor 800 by cameras 714, 720, the processor 800 instructs labeler 718 to apply the scratch off label 756 over the first promotion code image 750 and the first promotion image 752 to hide them both. Next, in response to the sensed position of the web 705 as indicated to the processor 800 by cameras 714, 720, the processor 800 instructs the upper TTO printer 704B to print the message M on the label 756 at the appropriate location. As noted herein, the printing and label applications occur on the fly as the web 705 moves upward through the module 700. In some configurations, an input/output module may be located between the processor 800 and one or more of the other components illustrated in FIG. 13 in order to condition processor signals provided to one of the components and/or in order to condition signals provided by one or more of the components to the processor. Also, in order to facilitate timing of the various components, a real time kernel clock, e.g., Ardence RTX, may be used to provide a time reference for the system of FIG. 13. Not all images and codes are required, depending on the type of promotion or tracking desired.

In one embodiment, the invention comprises a system and method for promoting and tracking products and for receiving feedback from consumers of the products. For example, bags of potato chips to be provided to a particular store may have several different promotions. Each bag or group of bags is marked with a unique ID code image 754 which may be used to track and sort the bags for delivery at the particular store location. Each bag or group of bags is also marked with a unique promotion code image 750. The bags may have the same or different promotion images 752 and the same or different messages M. When a consumer purchases a bag and scratches off the SOL 756, the consumer responds to the promotion image 752. This means the consumer may “cash in” on an offer or discount that is provided and/or the consumer may be directed to a website (e.g., a social networking site). If the consumer accesses the website, the consumer may be provided with a survey to obtain consumer preferences and/or the consumer may be rewarded with additional promotions. At the website, the consumer may be requested to provide a scan of the unique ID code image (or provide its number or other identifying aspect) on the consumer's package and/or to provide a scan of the unique promotion code image (or number) on the consumer's package. As a result, the bag supplier is able to track individual bags and obtain feedback as to which products and promotions are preferred or not preferred by consumers.

As another example, bags or group of bags of potato chips to be provided to a particular store may be have several different promotions and bags or group of bags of pretzels to be provided to the same particular store may have several different promotions. Each bag or group of bags is marked with its unique ID code image 754 which may be used to track and sort the bags for delivery at the particular store location, as noted herein. Each bag or group of bags is also marked with its unique promotion code image 750. Sales of the bags can be monitored to determine consumer preferences to potato chips vs. pretzels and to particular promotions provided with each. As a result, the bag supplier is able to track individual bags and obtain feedback as to whether chips or pretzels and their related promotions are preferred or not preferred by consumers. Depending on the type of feedback desired and types of promotions, sorting bags for delivery may be optional.

As yet another example, bags or group of bags of potato chips to be provided to a particular store may have several different promotions and bags or group of bags of pretzels to be provided to the same particular store may have several different promotions. Each chip bag or group of bags is marked with a first unique ID code image 754 which may be used to track and sort the bags for delivery at the particular store. Each chip bag or group of bags is also marked with a first unique promotion code image 750. Each pretzel bag or group of bags is marked with a second unique ID code image 754 which may be used to track and sort the bags for delivery at the particular store. Each pretzel bag or group of bags is also marked with a second unique promotion code image 750. Sales of the bags can be monitored to determine consumer preferences to potato chips vs. pretzels and to particular promotions provided with each. As a result, the bag supplier is able to track individual bags and obtain feedback as to whether chips or pretzels and their related promotions are preferred or not preferred by consumers. Routing and delivery of bags may also be controlled by the unique ID code images so that certain bags may be sent a particular location. For example, chip bags may be sent to one location and pretzel bags to another or certain chip bags certain pretzel bags can be sent to one location and other bags can be sent to other locations.

In general, the first promotion codes may be different from the second promotion codes; the first ID codes may be different from the second ID codes; and the first promotions may be different from the second promotions.

Each of the first and second promotion codes may be unique; each of the first and second ID codes may be unique; and each of the first and second promotions may be unique. Alternatively, the first promotion codes may be the same as the second promotion codes; the first ID codes may be different from the second ID codes; the first promotions may be the same as the second promotions; each of the first and second promotion codes may be the same; each of the first and second ID codes may be same; and each of the first and second promotions may be same. Any combination of the above scenarios is also contemplated and is possible with the invention, particularly because the invention in one form is database driven to apply the codes and promotions on the fly and the ID codes allow tracking of each product or group of products.

In summary, the module 700 is for use with a product packaging delivery system for supplying a plurality of product packaging material (PPM) packages such as a web 705 of continuous packages. The module 700 includes the memory 802 including a first data record for first products and defining the first ID code, the first promotion and the first promotion code. In addition, the memory includes a second data record for second products and defining the second ID code, the second promotion and the second promotion code. The first products may be same or different than the second products. A printing system such as TTO printer 704A apply to a selected number of the PPM packages a first image comprising the first ID code image 754 corresponding to the first ID code, the first promotion image 752 corresponding to the first promotion, and the first promotion code image 750 corresponding to the first promotion code. In addition, the printing system applies to a selected number of the PPM packages a second image comprising the second ID code image 754 corresponding to the second ID code, the second promotion image 752 corresponding to the second promotion, and the second promotion code image 750 corresponding to the second promotion code.

In one form, the invention comprises a method of marking individual products, distributing the marked products, tracking the marked products and/or collecting feedback from consumer of the marked products.

For simplicity and convenience as described herein, the module 700, system and method of the invention have been described with regard to two different types of products with two different types of packaging. It is also contemplated that the module 700, system and method of the invention is applicable any number more than two types of products. Alternatively or in addition, the products may all be the same and each package may have its own data file and may be unique from every other package, having different codes and/or promotions. For example, each package of a product would have its own unique ID code, promotion code and promotion. Other combinations are also contemplated wherein some but not all packages would have the same ID code but different promotions and promotion codes, or some but not all packages would have the same promotion code but different promotions and ID codes, and/or some but not all packages would have the same promotions but different promotion codes and ID codes. Furthermore, messages on the SOLS, if there are any, may be the same or different. All these variations allow a supplier to test market various products in various channels of distribution with various promotions or incentives. The unique codes allow tracking of the products after purchase as the products can be identified when promotions are redeemed or when a customer provides information via a website (e.g., a social networking site) or questionnaire site or feature or mobile phone app.

As noted herein, the various combinations also allow control and tracking of the distribution of products so that particular products, particular packaging and/or particular promotions may be targeted to a specific geographic area and/or to a specific consumer or group of consumers.

A layering system such as SOL labeler 718 applies a removable layer (SOL 756) over a portion of the first image so that the applied removable layer (SOL 756) covers the first promotion image 752 and covers the first promotion code image 750 but does not cover the first ID code image 754. The layering system also applies the removable layer (SOL 756) over a portion of the second image so that the applied removable layer covers the second promotion image 752 and covers the second promotion code image 750 but does not cover the second ID code image 754. An additional printing system for applying a message image on each of the removable layers.

A controller 800 is linked to the memory 802, the printing system 704A, the layering system 718 and the additional printing system 704B for controlling the operation of the printing system 704A, the layering system 718 and the additional printing system 704B to print the first image on some of the PPM packages partially covered by the removable SOL, to print the second image on the remainder of the PPM packages partially covered by the removable SOL, and to print the message image on each of the removable SOLS. As a result, the first number of the PPM packages for use with the first products have the first ID code image and the removable layer having the message visible thereon and having the first promotion image and the first promotion code image under the removable layer and not visible. Similarly, the second number of the PPM packages for use with the second products have the second ID code image and the removable layer having the message visible thereon and having the second promotion image and the second promotion code image under the removable layer and not visible.

In one embodiment, the module 700 is linked to a distribution system which reads the first ID code image 754 of the first PPM packages of the first products and distributes, in response to reading the first ID codes, the first products to a first retailer. Similarly, the distribution system reads the second ID code image of the second PPM packages of the second products and distributes, in response to reading the second ID codes, the second products to a second retailer different from the first retailer. In this embodiment, information identifying the destination retailer of each product is part of the date record in the memory which is associated with each product.

As illustrated, the PPM packages may be a web of continuous packages and any imaging system may be used for monitoring images on the web to identify the location of the images on the web relative to the printers 704A, relative to the layering device 718, and relative to the additional printer 704B. The controller 800 is linked to and responsive to the imaging system for controlling the operation of the printer 704A, the layering device 718, and the additional printer 704B.

In one embodiment, the web includes a registration mark or other indicator instead of or in addition to the ID code for indicating a location of packages of the web. The imaging system monitors and is responsive to the registration indicator and/or ID code.

As noted above, the relative alignment of the printers, labeler and cameras is important. Thus, a frame assembly may be used for supporting the printers 704 and the layering device 718 relative to the web. The frame assembly includes a subassembly connected to the printers and the layering device for simultaneously moving the printers and the layering device at a single unit relative to the web.

In one embodiment, the printer comprises a first TTO printer 704A for printing the first code image 750 and the first promotion image 752 on the web 705, the layering device comprises a scratch off label applicator 718 applying a scratch off label 756 to the web to cover the printed first code image 750 and to cover the printed first promotion image 752, and the additional printer comprises a second TTO printer 704B for printing the message image M on the scratch off label 756.

In general, the system and method of the invention may include any imaging system for monitoring images on the web 705 to identify the location of the images 750, 752, 754 on the web relative to the printers 704 and relative to the label applicator 718. The controller 800 is linked to and responsive to the imaging system for controlling the operation of the printers and the label applicator.

### Custom Ingredients

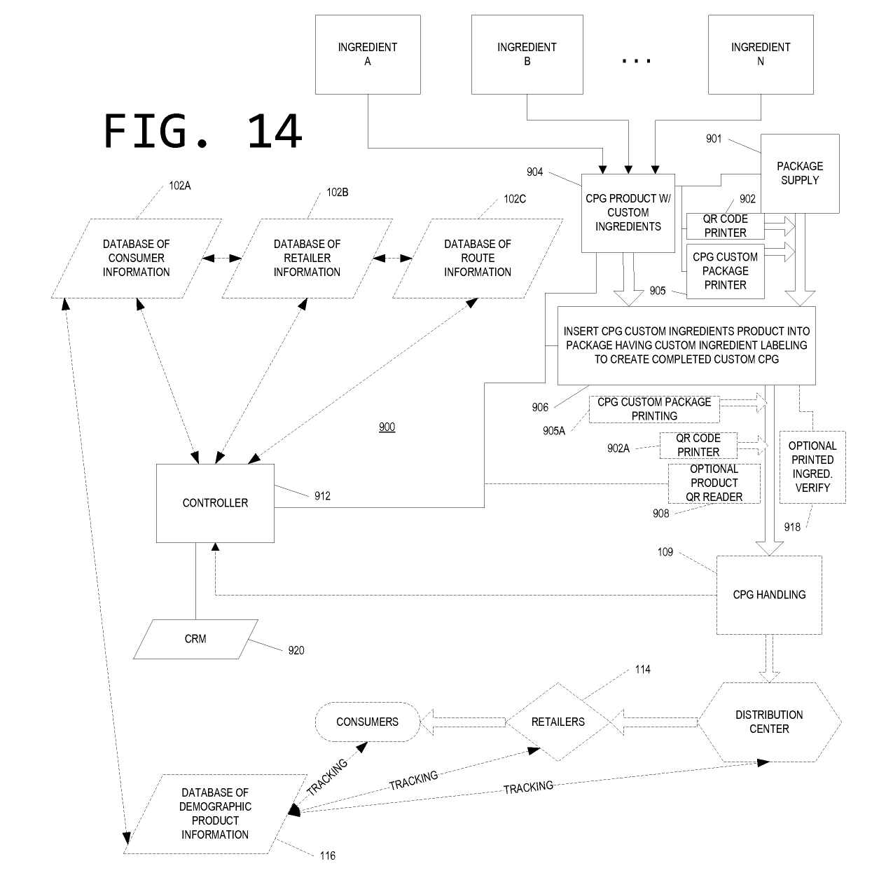

FIG. 14 is a block diagram of one embodiment of a system 900 and method of the invention for the manufacture of CPG products having custom (variable) ingredients, optionally based on at least one of consumer information, retailer information, demographic product information and/or demographic package information. This system and method are applicable for the production and distribution of products to various consumers that have a sensitivity to ingredients. Such products are frequently made with a variable ingredient list and/or a date driven ingredient list. Date driven lists may change based on the date of production or various lists may have different expiration dates. The ingredient list may also change based on available ingredients at the time of production.

The system 900 includes a product supply device such as a device 904 which selectively combines one or more of ingredients A, B . . . , N in order to deliver a CPG product with custom ingredients. The device 904 sequentially, continuously supplies a plurality of products, each having a particular, unique set of ingredients. Each set of ingredients is different than another set of ingredients. For example, some products may have a set of ingredients which include wheat while others may be wheat-free. As another example, some products may have a set of ingredients which include peanuts while others may be peanut-free. As another example, some products may have a set of ingredients which include gluten while others may be gluten-free.

As a specific example, the same basic product may have different ingredients. Two types of potato chips may be sold in the same packaging. The only difference in the packaging is that packages with one type of chips would have one type of ingredients printed thereon and packages with the other type of chips would have the other type of ingredients printed thereon. One type of chips may be cooked in peanut oil whereas the other type of chips may be cooked in canola oil. Packages with the peanut oil chips would have ingredients including peanut oil printed thereon and packages with the canola oil chips would have ingredients including canola oil printed thereon. Optionally, the packages may be custom marked to indicate which type of oil was used for cooking.

A package supply device 901 supplies a plurality of packages, one package for each of the plurality of products, simultaneously with the supply of custom ingredient products supplied by the product supply device 904. Frequently, these packages are a pre-printed web with the product name and related graphics. The supplied packages may all be the same or they may vary. A CPG custom package printing device 905 prints on each respective package the particular set of ingredients of the product to be associated with the respective package. The printer 905 may have a built-in camera (not shown) for reading the pre-printed product on the package and printing a corresponding ingredient list thereon. Alternatively or in addition, a printing device 905A and/or printer 902A may be located after a combining device 906 combines the products and packages to provide the printing of customized ingredients or other custom information.

In one alternative embodiment, a unique QR code is also printed on each package by a printer 902 so that each package is unique and different from every other package and each package can be individually tracked. Printer 905 may also have a built-in camera (not shown) to read packaging. Alternatively, a QR may be printed on the package which corresponds to the ingredients of the package so that products with the same ingredients would have the same QR code.

After printing of the ingredients by CPG custom package printing device 905, the combining device 906 inserts or otherwise associates each unique CPG product having a unique set of custom ingredients with the custom printed packages supplied by the package supply device 901. As a result, each custom product is associated with its custom package having its unique custom ingredients printed thereon. As an alternative, it is also contemplated that either printers 902, 905 may print the QR code and/or custom ingredients onto a label applied to the package before or after the product is associated with the package.

A controller 912 is connected to the product supply device 904, the package supply device 901 and printers 902, 905 (e.g., via the product supply device 904) and the combining device 906. The controller 912 coordinates the sequential operation of the product supply device 904, the package supply device 901, the printers 902, 905 and the combining device 906 so that each custom product is associated with its custom package having the custom ingredients printed thereon.

If a QR code printer 902 is employed, either before or after the combining device 906, an optional product QR reader 908 may be located thereafter to verify that the QR code has been printed accurately and/or to track each product. Either before or after the combining device 906, an optional verifying reader 918 may be located thereafter to verify that the custom ingredients have been printed accurately and/or to track each product based on their ingredients. The reader 908 and verifying reader 918 may be the same device or separate devices located at the same or different locations.

As the illustrated in phantom in FIG. 14, it is contemplated that one or more of the CPG handing 109, distribution center 110 and databases 102, 116 may be implemented in conjunction with the variable ingredient system of FIG. 14. The implementation would be substantially the same as illustrated and described above regarding FIGS. 1-2. For example, certain products with certain ingredients may be targeted to one retailer having certain customers whereas other products with other ingredients may be targeted to another retailer having other customers. If the products are palletized for distribution, one tier of certain products may be stacked for the first retailer and another tier of the other products stacked for another retailer, both tiers on the same pallet. Alternatively, a variety of different products with different ingredients may be targeted to a particular retailer. In this scenario, a tier having both certain and other products would be stacked on one tier of a pallet for the particular retailer.

In one embodiment, a data record stored in a tangible computer readable medium (CRM) 920 (i.e., a storage device) indicates a first number of first products having a first set of ingredients and indicates a number of second products having a second set of ingredients. The first set of ingredients is different than the second set of ingredients. The controller 912 is responsive to the data record to instruct the product supply device 904 to supply the first number of first products having the first set of ingredients. The controller is also responsive to the data record to instruct the product supply device 904 to supply the second number of second products having the first set of ingredients. In addition, the controller is responsive to the data record to instruct the printing device 905 to print the first set of ingredients on the first packages of the first products and to print the second set of ingredients on the second packages of the second products.

In one embodiment, the product supply device 904 sequentially supplies on-the-fly a first product having a first set of ingredients, a second product having a second set of ingredients, a third product having the first set of ingredients, a fourth product having the second set of ingredients from a continuous web of successive, sequential packages. The first set of ingredients is different than the second set of ingredients. In this embodiment, the printing device 905 prints the first set of ingredients on the packages associated with first and third products and prints the second set of ingredients on the packages associated with second and fourth products.

In yet another embodiment, the printing device 905 is configured for printing on each respective package the particular set of ingredients of the product to be associated with the respective package. In this embodiment, the combining device 906 is configured for associating each of the products to one of the packages after printing.

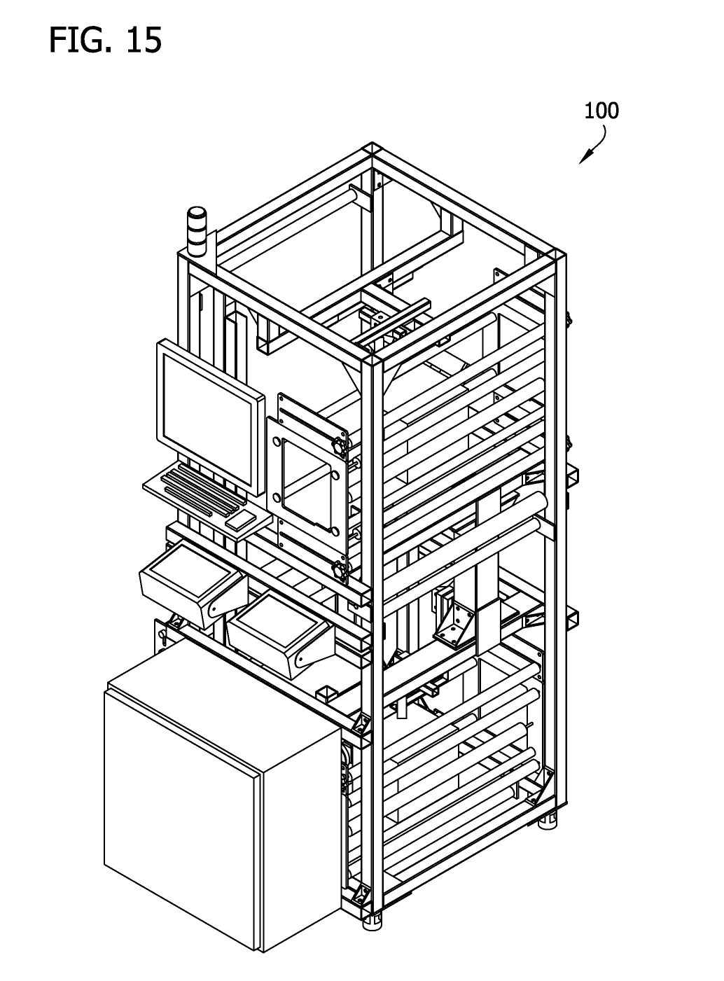

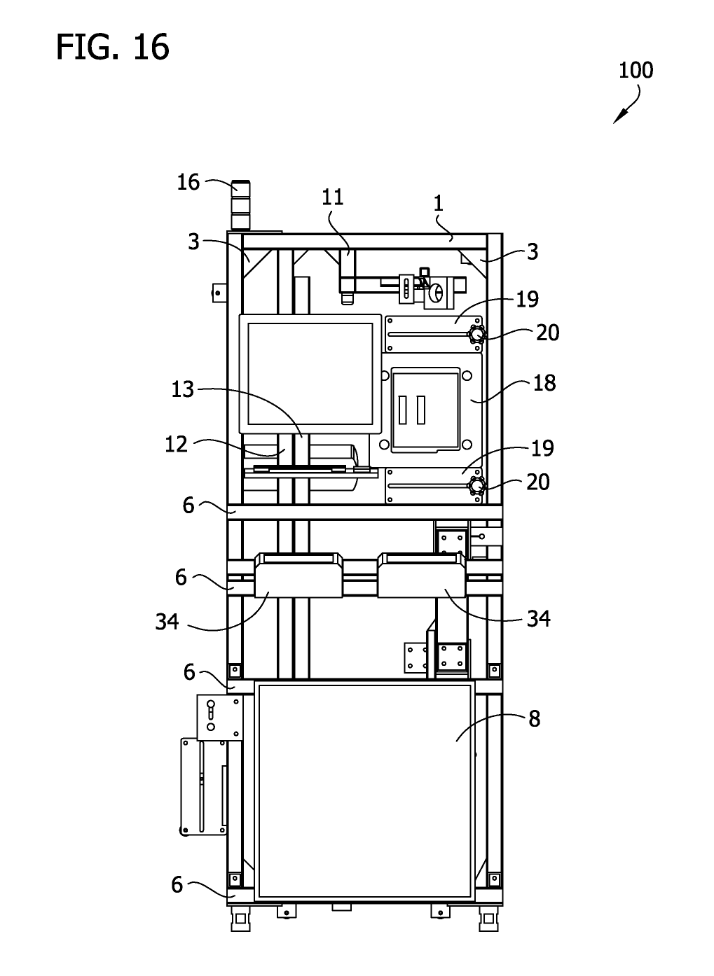

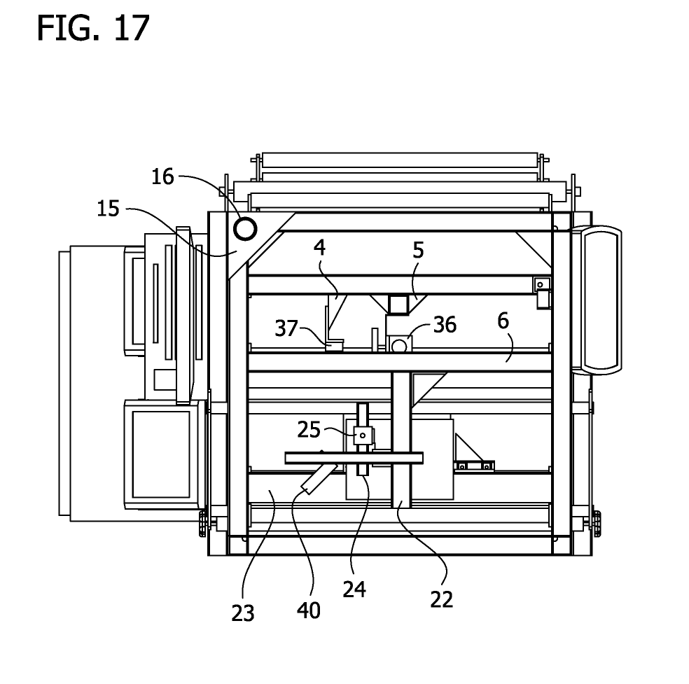

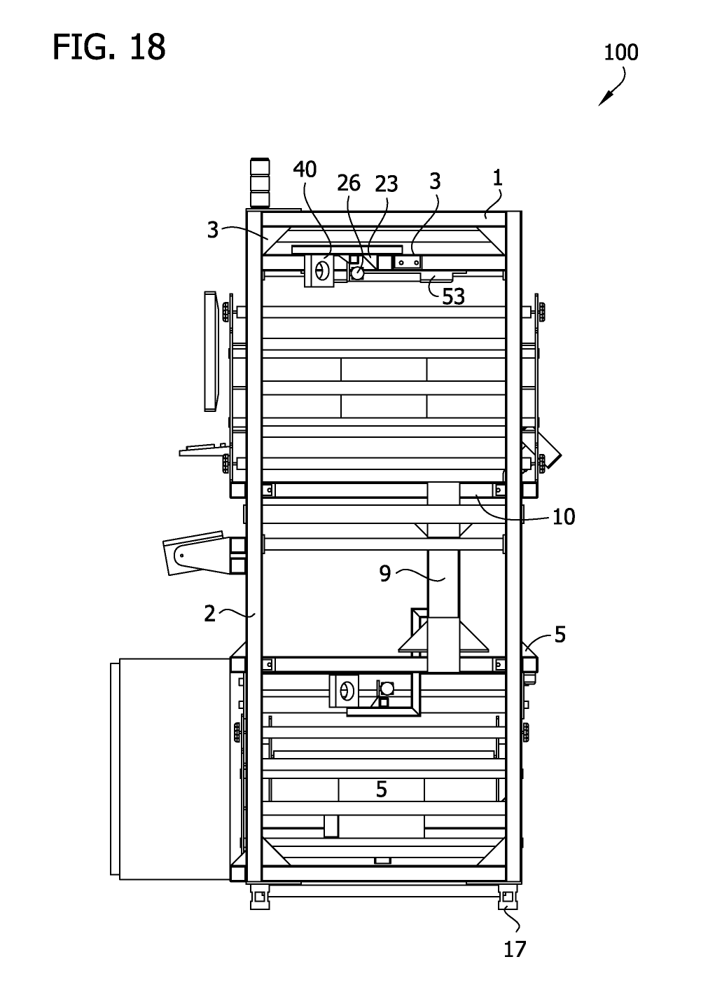

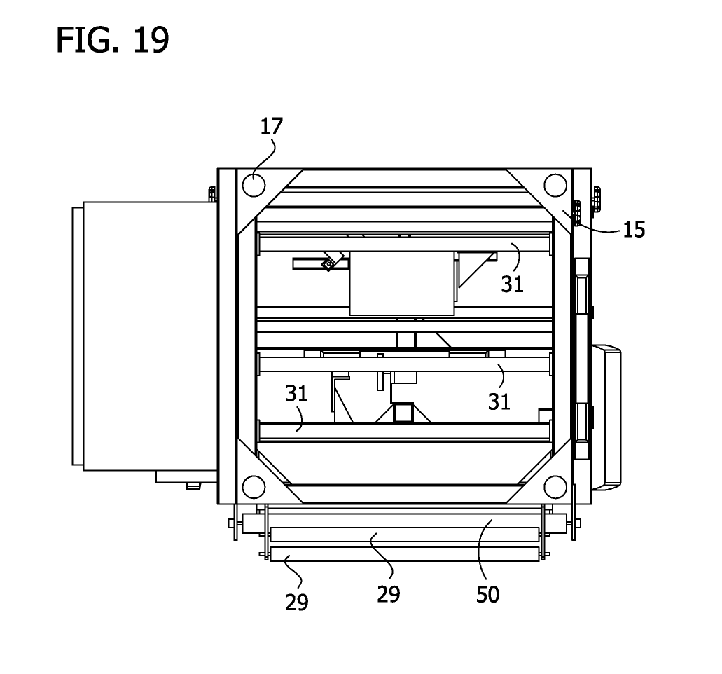

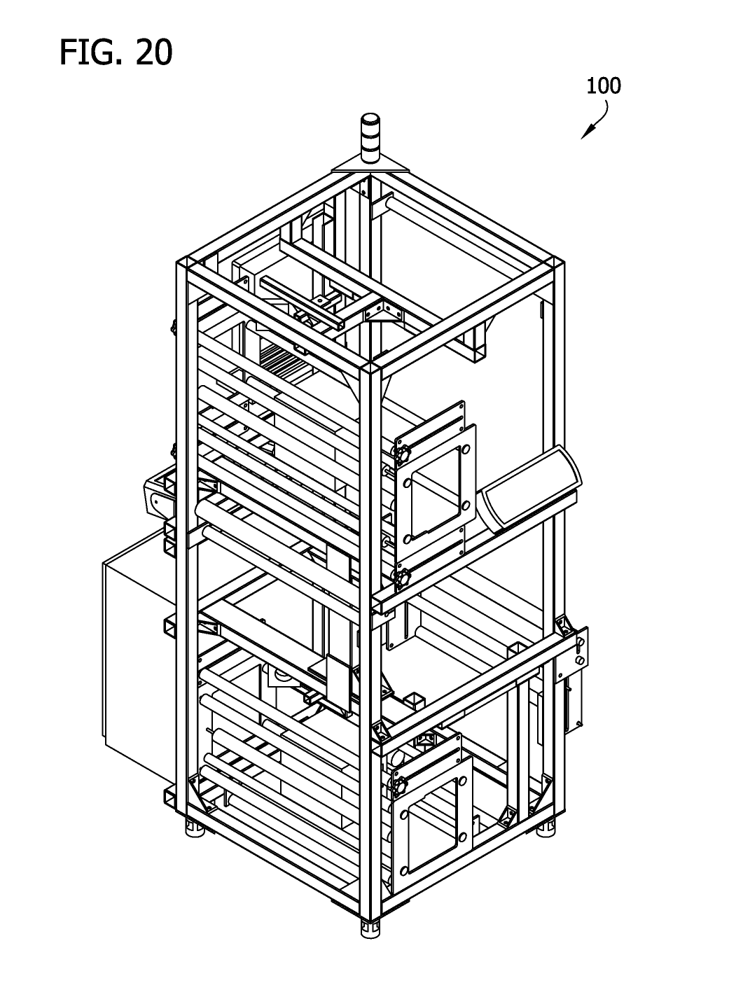

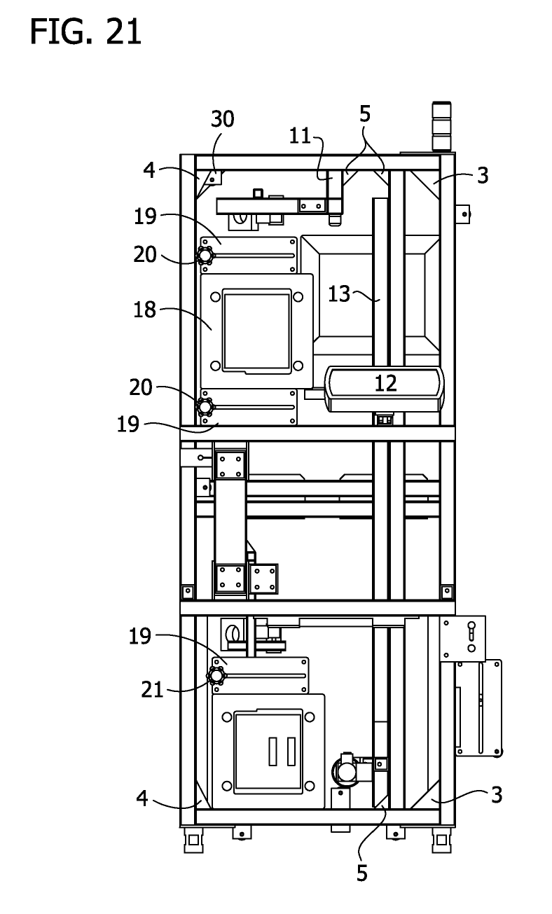

FIGS. 15-21

FIGS. 15-21 illustrate a front perspective view another embodiment of a stand-alone module 100 similar to module 700 for use in conjunction with a typical web of product packaging material (PPM) packages, according to one embodiment of the invention. In FIGS. 15-21, the following are illustrated:
Extrusions: 1, 2, 6, 7, 9-14, 22-24, 35, 41-43
Brackets: 2-4, 25, 45, 52
Anodized Rollers: 20, 21, 29, 31
Mounting Plates: 28, 30, 40, 46, 47, 49, 55
Electrical Enclosure 8
Caster Gusset 15
Light Tower 16
Casters 17
DataFlex Plus Video Jet Bracket Assembly 18
Slotted Mounting Plate 19
Slotted Mounting Plate 32
DataFlex Plus Video Jet Interface Bracket 33
DataFlex Plus Video Jet Interface 34
Encoder 36
Photo Eye Sensor 37
Computer Monitor 38
Computer Keyboard 39
Smart Vision Lights 40
DataFlex Plus Bracket Assembly 48
Red Rubberized Roller 50
Dataflex Label Applicator Interface Panel 51
Hammond Light 53
Stainless Steel Roller 54

In FIGS. 15-21, module 100 adds a layered promotion on-the-fly to a continuous moving web of sequential, individual, successive product packages. The electrical enclosure holds a computer with a memory including a plurality of data records defining a plurality of promotion codes and at least one additional data record defining a non-promotion code. The extrusions, brackets, rollers and related components noted above comprise a frame for receiving and supporting the web of packages including guides for guiding the web through the frame as the web moves through the frame. A printer (such as a Dataflex Plus Video Jet printer, not shown; see, for example, printer 704 above) is supported by brackets and an interface of the frame for printing one of the codes to one of the packages of the web. A layering device (such as a Dataflex Label Applicator; see labeler 718, above) is supported by brackets and an interface of the frame for applying a removable layer (such as a SOL) to one of the packages over each of the printed codes of the packages.

A tracking system (such as a photo eye, encoder, smart vision light and/or imaging devices; for example, one or more of cameras 714, 720, above) is supported by the frame for tracking the position of each product package of the web relative to the printer and the layering device. The photo eye sensor 37 reads indexing marks on the edge of the web indicating the start or position of each package. The encoder 36 includes a friction wheel which tracks web movement and web position between indexing marks so that the position of the web and the packages relate to the printer and label application is known at any point in time. The lights illuminate the web to allow imaging devices to capture images of the graphics on the web to verify web position, proper printing and/or proper label application.

The computer held in the electrical enclosure comprises a controller linked to the memory, the printer, the layering device and the tracking system. The controller controls the timing and the operation of the printer to print the printed code at a selected location on each package. Simultaneously, the controller synchronously controls the operation of the layering device to apply one of the removable layers over the printed code at the selected location on each package. Optionally, a second printer (not shown; see for example printer 704B above) is supported by the frame and synchronously controlled by the controller for printing on the removable layer after the layering device applies the removable layer to one of the packages.

As illustrated in FIGS. 1-6, the invention includes a system comprising a database, a product supply system, a marking system, an identification system, a distribution system and a controller.

The database includes a data record A of a consumer A served by a first retailer, a data record B of a consumer B served by the first retailer, a data record C of a consumer C served by a second retailer and data record D of a consumer D served by the second retailer. The data records are different from each other, the consumers are different from each other, and the retailers are different from each other.

The product supply system supplies a product A associated with the data record A, supplies a product B associated with the data record B, f supplies a product C associated with the data record C, and supplies a product D associated with the data record D;

The marking system applies a unique identifier to each product and applies an element corresponding to its unique identifier. The marking system applies an element A including information A from the data record A to the product A having unique identifier A, applies an element B including information B from the data record B to the product B having unique identifier B, applies an element C including information C from the data record C to the product C, and applies an element D including information D from the data record D to the product D, wherein the information is different from each other and wherein the elements are different from each other.

The identification system identifies each of the products A, B, C, and D. The distribution system applies the identified products A and B to the first retailer and applies the identified products C and D to the second retailer. In general, the distribution system collects and/or distributes the packages in some intelligent scheme as noted herein to various locations according to the variable images, including selective grouping, cartoning, and/or palletizing for distribution to various locations according to the variable images on the packages.

The controller linked to the database and linked to the identification system controls the operation of the product supply system, the marking system and the distribution system.

Optionally, the database includes distribution system information, retailer information and/or consumer feedback information regarding the products from the distribution system, retailers and/or consumers of the products. The products are distributed based on the feedback information.

Optionally, the product supply system comprises a product manufacturing system manufacturing the product A in accordance with data record A, manufacturing the product B in accordance with data record B, manufacturing the product C in accordance with data record C, manufacturing the product D in accordance with data record D, wherein each of the products is different from each other.

Optionally, a print verification system monitors the product marking to confirm that each product has the correct element which corresponds to the identifier on the product.

Optionally, the controller reorders product out of order and/or re-sequences product out of sequence.

As illustrated in FIGS. 1-6, the invention includes a system comprising database, a supply system, a marking system, an identification system, a distribution system, and a controller.

The database stores information regarding a first demographic group in a first area, a second demographic group in a second area, first retailers in the first area and second retailers in the second area.

The supply system supplies a first product according to information in the database regarding the first demographic group and supplies a second product according to information in the database regarding the second demographic group.

The marking system applies a first mark to the first products and applies a second mark to the second products wherein the first mark includes information from the database regarding the first demographic group and wherein the second mark includes information from the database regarding the second demographic group.

The identification system identifies the first products and the second products.

The distribution system distributes the identified first products to the first retailers in the first area and distributes the second products to the second retailers in the second area.

The controller linked to the database and the identification system provides information to and controlling the operation of the supplying system, the marking system and the distribution system.

Optionally, the database includes distribution system information, retailer and/or consumer feedback information regarding the products from the distribution system, retailers and/or consumers of the products, and the products are distributed based on the feedback information.

As illustrated in FIGS. 1-6, the invention includes a system for use with products comprising a database, a marking system, an identification system, a distribution system, and a controller.

The database stores information regarding a first demographic group in a first area, a second demographic group in a second area, first retailers in the first area and second retailers in the second area.

The marking system applies a first mark to the products wherein the first mark targets the first demographic group in the first area. The marking system also applies a second mark to the products wherein the second mark targets the second demographic group in the second area.

The identification system identifies first products having the first mark and identifies second products having the second mark.

The distribution system distributes identified first products to the first retailers in the first area and distributes second products to the second retailers in the second area.

The controller linked to the database and responsive to the identification system controls the operation of the marking system and the distribution system.

As shown in FIGS. 1-6, the invention includes method for use with a database including a data record A of a consumer A served by a first retailer, a data record B of a consumer B served by the first retailer, a data record C of a consumer C served by a second retailer and data record D of a consumer D served by the second retailer, wherein the data records are different from each other, wherein the consumers are different from each other, and wherein the retailers are different from each other. A product A associated with the data record A is supplied. A product B associated with the data record B is supplied. A product C associated with the data record C is supplied. A product D associated with the data record D is supplied.

A mark A including information A from the data record A is applied to the product A. A mark B including information B from the data record B is applied to the product B. A mark C including information C from the data record C is applied to the product C. A mark D including information D from the data record D is applied to the product D. The information is unique and different from each other and the marks are unique and different from each other.

Each of the products A, B, C, and D is identified. The identified products A and B are distributed to the first retailer and the identified products C and D are distributed to the second retailer, different from the first retailer.

The product supply, the mark application and the distributing are controlled as a function of the database and as a function of the identifying of each of the products.

As illustrated in FIGS. 1-6, the invention includes a method comprising:
supplying a plurality of products, each having a unique identifier;
providing a database including a unique data record for each of the plurality of products, each data record corresponding to one of the supplied products;
reading the unique identifier of each of the products and in response thereto applying a unique mark to each of the products including information from the record corresponding to each product;
reading the unique identifier of each of the unique products and in response thereto distributing a first group of the unique products to a first retailer based on the records corresponding to the first group and distributing a second group of the unique products to a second retailer, different from the first retailer, based on the records corresponding to the second group; and
controlling the product supply, the mark application and the distributing as a function of the database and as a function of the identifying of each of the products.

As shown in FIG. 14, the invention includes a system comprising a product supply device, a package supply device, a printing device, a combining device, and a controller.

The product supply device sequentially, continuously supplies a plurality of products, each having a particular set of ingredients wherein each set of ingredients is different than another set of ingredients.

The package supply device supplies a plurality of pre-printed packages, one package for each of the plurality of products.

The printing device prints on each respective package the particular set of ingredients of the product associated with the respective package.

The combining device associates each of the products to one of the packages.

The controller is connected to the product supply device, the package supply device and the combining device for coordinating the sequential operation of the product supply device, the package supply device and the combining device.

Optionally, a data record stored in a tangible computer readable medium and indicates a first number of first products having a first set of ingredients and indicates a number of second products having a second set of ingredients. The first set of ingredients is different than the second set of ingredients. The controller is responsive to the data record to instruct the product supply device to supply the first number of first products having the first set of ingredients. The controller is also responsive to the data record to instruct the product supply device to supply the second number of second products having the first set of ingredients. The controller is also responsive to the data record to instruct the printing device to print the first set of ingredients on the first packages of the first products and to print the second set of ingredients on the second packages of the second products.

Optionally, the product supply device sequentially supplies a first product having a first set of ingredients, a second product having a second set of ingredients, a third product having the first set of ingredients, a fourth product having the second set of ingredients, wherein the first set of ingredients is different than the second set of ingredients; and

The printing device prints the first set of ingredients on the packages associated with first and third products and prints the second set of ingredients on the packages associated with second and fourth products.

Optionally, the printing device is configured for printing on each respective package the particular set of ingredients of the product to be associated with the respective package; and wherein the combining device is configured for associating each of the products to one of the packages after printing.

In one form, a system comprises:
A product supply system for supplying a plurality of products, each having a unique identifier;
A database including a unique data record for each of the plurality of products, each data record corresponding to one of the supplied products;
A marking system for reading the unique identifier of each of the products and for applying a mark to each of the products including information from the record corresponding to each product;
A distribution system for reading the unique identifier of each of the unique products and for distributing a first group of the unique products to a first retailer based on the records corresponding to the first group and for distributing a second group of the unique products to a second retailer, different from the first retailer, based on the records corresponding to the second group; and
A controller linked to the database for controlling the operation of the marking system and the distribution system based on the data records in the database.

In another form, the invention includes a method or system for use with a product packaging delivery system for supplying a plurality of product packaging material (PPM) packages, including a memory, a printing system, a layering system, an additional printing system and a controller.

The memory includes a first data record for first products and defining a first ID code, a first promotion and a first promotion code. The memory also includes a second data record for second products and defining a second ID code, a second promotion and a second promotion code.

The printing system applies to a first number of the PPM packages a first image comprising a first ID code image corresponding to the first ID code, a first promotion image corresponding to the first promotion, and a first promotion code image corresponding to the first promotion code. The printing system applies to a second number of the PPM packages a second image comprising a second ID code image corresponding to the second ID code, a second promotion image corresponding to the second promotion, and a second promotion code image corresponding to the second promotion code.

The layering system applies a removable layer over a portion of the first image so that the applied removable layer covers the first promotion image and covers the first promotion code image but does not cover the first ID code image. The layering system also applies the removable layer over a portion of the second image so that the applied removable layer covers the second promotion image and covers the second promotion code image but does not cover the second ID code image.

An additional printing system applies a message image on each of the removable layers.

A controller linked to the memory, the printing system, the layering system and the additional printing system controls the operation of the printing system, the layering system and the additional printing system to print the first image on some of the PPM packages partially covered by the removable layer, to print the second image on the remainder of the PPM packages partially covered by the removable layer, and to print the message image on each of the removable layers.

As a result, the first number of the PPM packages for use with the first products have the first ID code image, the removable layer having the message visible thereon and having the first promotion image and the first promotion code image under the removable layer and not visible. The second number of the PPM packages for use with the second products have the second ID code image, and the removable layer having the message visible thereon and having the second promotion image and the second promotion code image under the removable layer and not visible.

In another form, the invention includes a method or system for use with a product packaging delivery system for supplying a plurality of product packaging material (PPM) packages comprising a memory, a printing system, a layering system and a controller.

The memory includes a first data record for first products which data record defines a first ID code and a first promotion. The memory also includes a second data record for second products which data record defines a second ID code and a second promotion.

The printing system applies to a first number of the PPM packages a first image comprising a first ID code image corresponding to the first ID code and a first promotion image corresponding to the first promotion. The printing system also applies to a second number of the PPM packages a second image comprising a second ID code image corresponding to the second ID code and a second promotion image corresponding to the second promotion.

The layering system applies a removable layer over a portion of the first image so that the applied removable layer covers the first promotion image but does not cover the first ID code image. The layering system also applies the removable layer over a portion of the second image so that the applied removable layer covers the second promotion image but does not cover the second ID code image.

A controller linked to the memory, the printing system, and the layering system controls the operation of the printing system, and the layering system to print the first image on some of the PPM packages partially covered by the removable layer, and to print the second image on the remainder of the PPM packages partially covered by the removable layer.

As a result, the first number of the PPM packages for use with the first products have the first ID code image and the removable layer having the first promotion image under the removable layer and not visible. The second number of the PPM packages for use with the second products have the second ID code image and the removable layer having the second promotion image under the removable layer and not visible.

It is also contemplated that the above is applicable to a continuous on-the-fly product line other than a web of packages. For example, cups and cans are frequently produced by a continuous on-the-fly product line. The above systems and methods are applicable to such product lines so a promotion, unique tracking code and layer may be applied to cups and cans before, during or after the cups and cans are formed or filled, during the continuous on-the-fly manufacture of such cups and cans.

### Form, Fill & Seal Machine

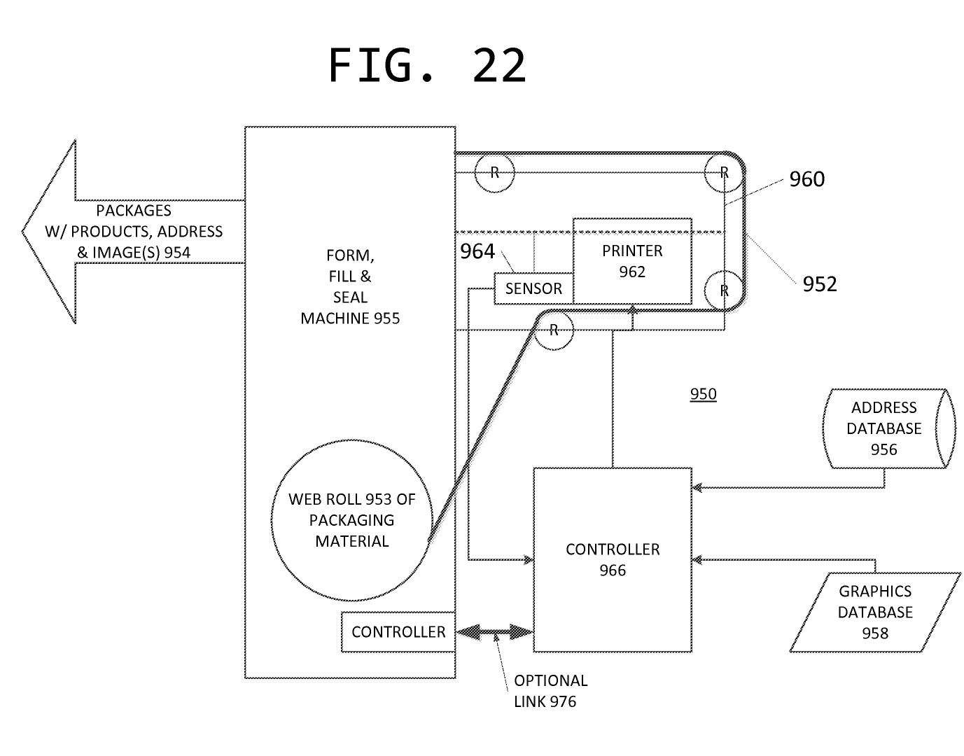

In one form, a database driven system 950 and method as illustrated in FIG. 22 are provided for use with a continuous, in-line moving web 952 provided by a roll 953 of flexible, continuous packing material from which successive product packages 954 are formed and filled with products. For example, the web may be part of a form, fill & seal machine 955. The system 950 includes an address database memory device 956 storing a plurality of addresses and a graphics database memory device 958 storing a plurality of images. Devices 956 and 958 may be a single device. A frame 960 engages the FFS machine 955 and receives and supports the web 952 of package forming material. It has guides (e.g., rollers R) for guiding the web 952 through the frame 960 as the web moves through the frame.

A printer 962 supported by the frame 960 adjacent the web 952 prints the images and the addresses on the web packages 954 on-the-fly as the web 952 moves through the frame 960. A sensor 964 supported by the frame 960 senses a location of the web 952 relative to the printer 962. A system controller 966 linked to the sensor 964, linked to the database memory devices 956, 958 and linked the printer 962, controls the operation of the printer 962 in response to the sensor 964.

As a result, the printer 962 prints one or more selected images from the graphics database 958 and a selected address from the address database 956 at locations along the web 952 to provide individual, successive product packages on the web. Each package includes an address and the selected image(s).

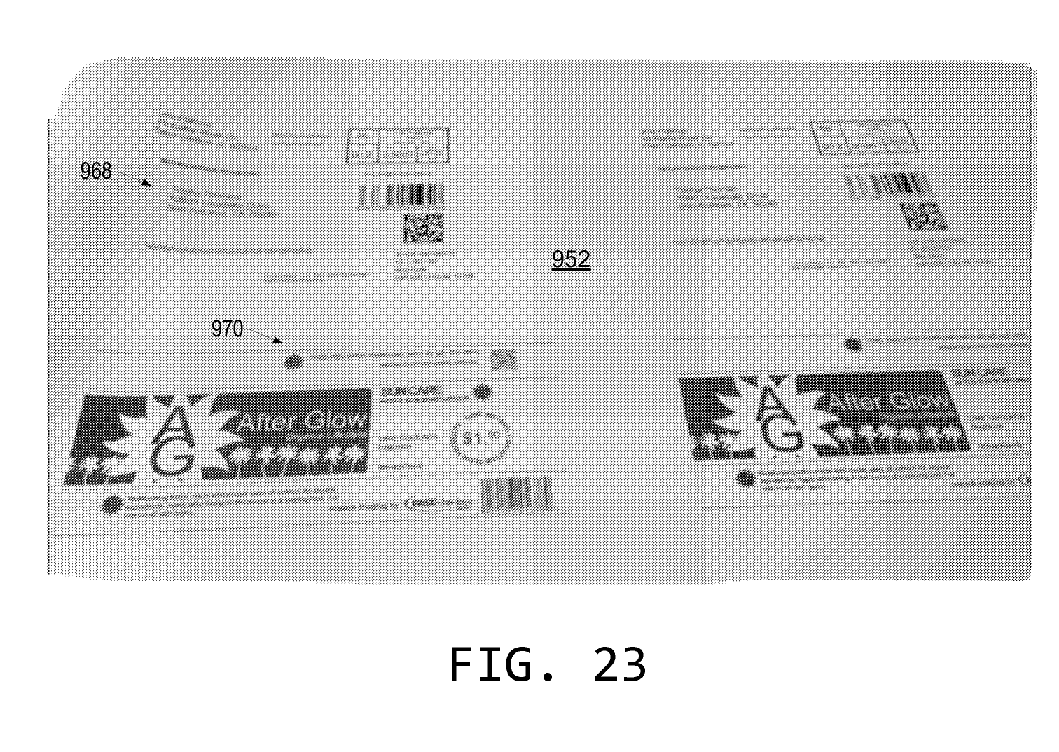

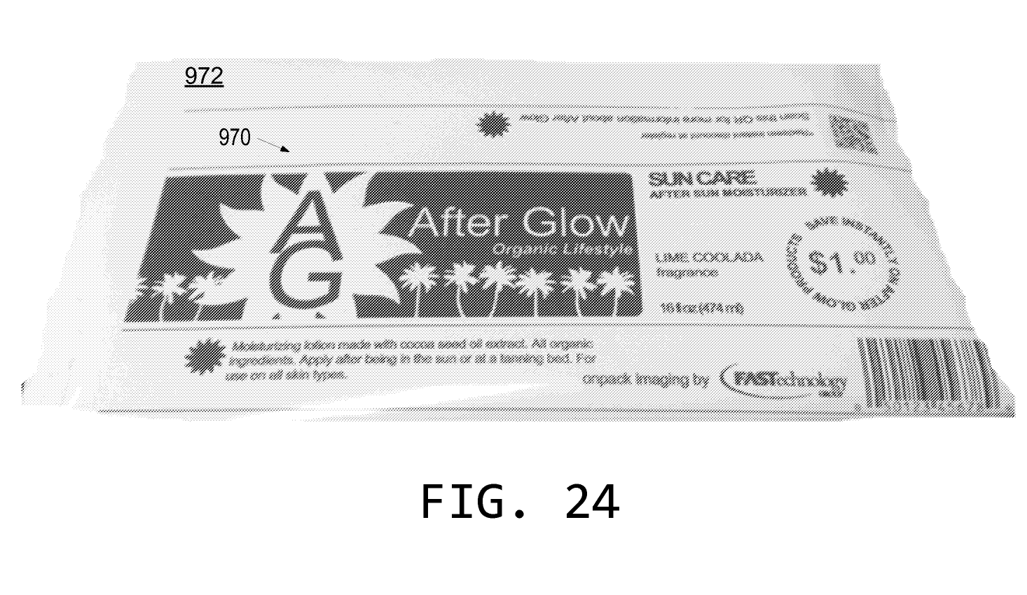

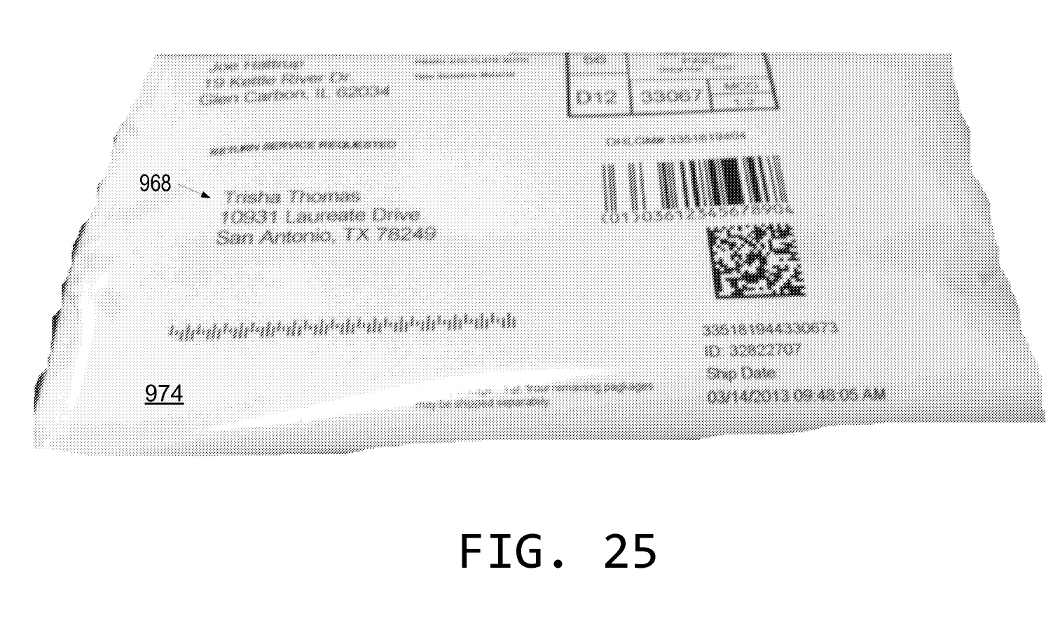

For example, FIG. 23 is a photo of an exemplary web 952 for use in a form, fill & seal machine for create a package, the web having an address 968 and a graphics image 970 printed thereon in accordance with the methods and systems herein. FIG. 24 is a photo of the front 972 of an exemplary form, fill & seal package having a lotion sample therein and having been formed from the web pictured in FIG. 23. The front 972 includes the graphic image 970. FIG. 25 is a photo of the back 974 of the exemplary form, fill & seal package having a lotion sample therein pictured in FIG. 24 and having been formed from the web pictured in FIG. 23. The back 974 includes the address 968.

In one form, the printer comprises an integrated printer-labeler as described above, so that printing occurs on either a blank or templated label as an in-line pre-operation on a web before it is formed into package and sealed. The printing and/or labeling is sequentially applied to the packaging material prior to creating a package by forming, filling and sealing the web.

Optionally, the system further comprises a distribution system for collecting and distributing the packages by mail (or similar direct-to-consumer distribution organization or methodology) to various locations according to the addresses.

In one form, the system further comprises a packaging machine for filling the packages, a packaging machine controller for controlling the operation of the packaging machine.

In one form, the controller coordinates with the packaging machine controller so that printing, and packaging are coordinated as part of one in-line, on-the-fly system.

Optionally, the system further comprises a form, fill & seal (FFS) machine having a controller for controlling its operation and further comprises a link 976 between the FFS controller and the system controller. The FFS controller is responsive to the system controller to control the operation of the FFS machine.

In one form, the system further comprises a database storing data indicative of the content of individual packages. The system controller controls the printer to create individual packages having an image and an address for a certain content. The system control via the link indicates to the FFS controller the content to be provided to each of the individual packages.

In one form, the content of the package comprises at least one of:
A product;
Printed materials;
A sample (e.g., laundry soap, lotion);
Nutrition Sublimates; and
A powdered drink.

In one form, the image in the graphics database is at least one of:
A coupon;
A game;
A link;
A personalized content relating to the corresponding address on the package;
A targeted Team logo (e.g., a local sports team logo of the addressee); and
Map graphic to local store or location.

Optionally, each of the addresses in the address database memory device corresponds to a particular image in the graphics database memory device, wherein each of the addresses corresponds to a content to be placed in a package to the address, wherein the system controller controls the printer to print each address and its corresponding image as one the packages to formed from the web and wherein the system controller controls the FFS controller to form, fill & seal the web into a package having the corresponding content, having the corresponding address and having the corresponding image.

The sensor comprises at least one of:
An encoder for sensing a position of the web relative to the printer,
A mark reader for sensing registration, index or other mark on the web, and
A sensor for sensing movement of the web relative to the printer.

In one form, each of the addresses in the address database memory device corresponds to a particular image in the graphics database memory device. The system controller controls the printer to print each address and its corresponding image as one the packages is formed from the web.

In one form, the above system comprises a database driven system for use with a form, fill & seal (FFS) machine having moving web from which successive product packages are formed, filled and sealed.

In one form, an add-on system to be added to a form, fill & seal machine is provided.

In one form, an apparatus comprising a form, fill & seal (FFS) machine with the systems as noted above is provided.

A database driven method for use with a form, fill & seal (FFS) machine having a moving web from which successive product packages are formed, filled and sealed, is provided. The method for use with an address database memory device storing a plurality of addresses, and a graphics database memory device storing a plurality of images.

The method comprises:
receiving and supporting the web of packages including guiding the web as the web moves;
printing the images and the addresses on the packages on-the-fly as the web moves;
sensing a location of the web; and
controlling the printing in response to the sensing to print a selected image and a selected address at locations along the web to provide individual, successive product packages on the web wherein each package includes an address and an image.

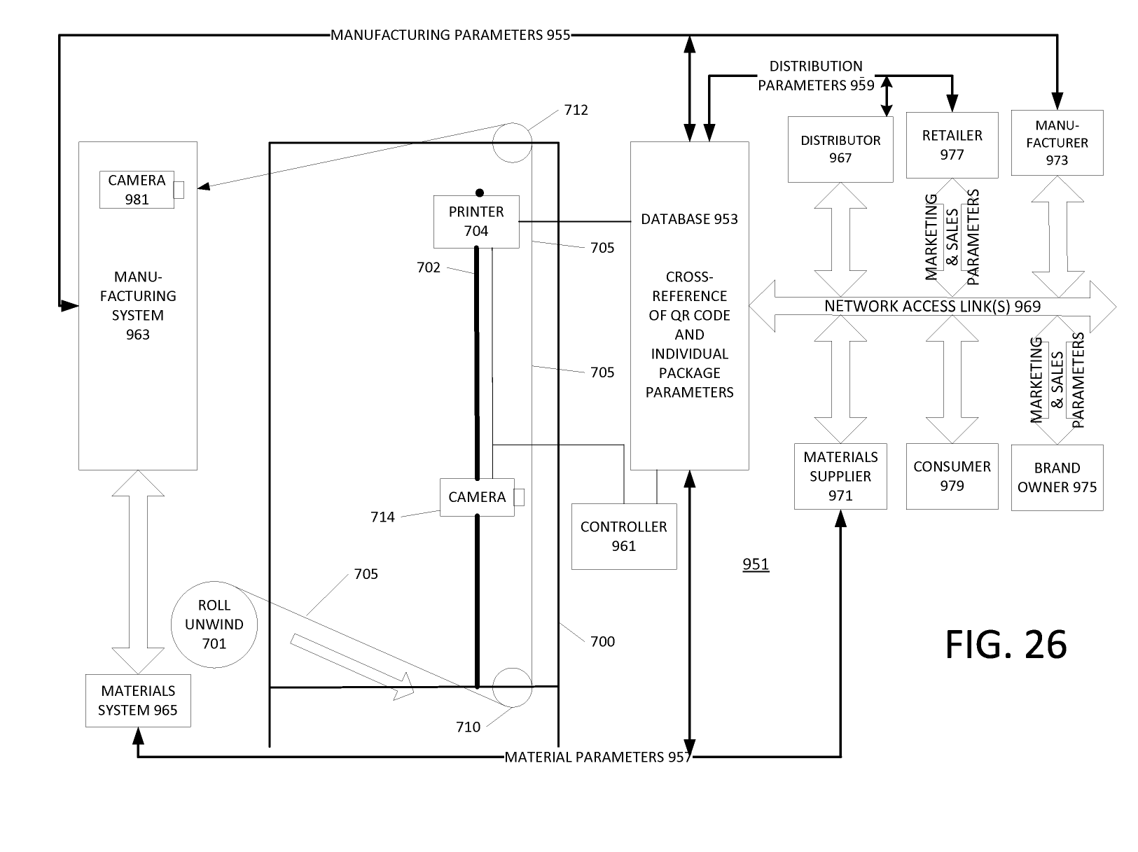

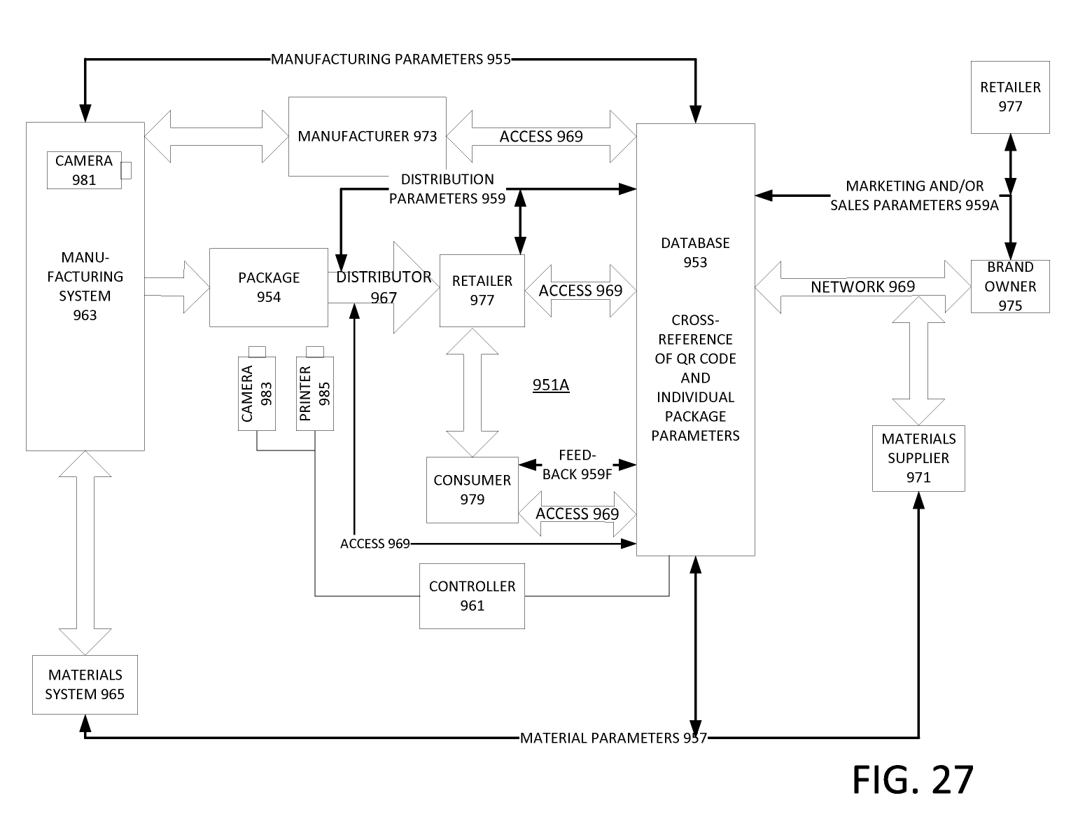

### FIGS. 26-27

In general, FIGS. 26 and 27 are systems which accumulate and track data regarding individual consumer package goods. The data is linked to a unique, individual QR code on each package. Selected data would be selectively available to entities such as manufacturers, material suppliers, distributors, retailers, brand owners and consumers. The QR code can be scanned by a mobile device of a consumer to access some or all of the information. Selected data would be available, depending on the entity. The data provides marketing, cross-merchandising, and management information, as well as other individualized package information.

FIG. 26 illustrates one embodiment of a system 951 for printing individual QR codes on a continuous web 705 from which individual consumer product packages are formed. A database 953 cross-references the QR code of each package to its unique package parameters. The package parameters includes one of more of manufacturing parameters 955, material parameters 957, distribution parameters 959, marketing parameters, and/or sales parameters. In one form, the data in the database 953 is catalogued in a standard format and would be independent of products and entities involved.

In this context, the individual QR code of a package comprises a “super SKU” with product DNA and unique characteristics at time of manufacturing, filling, distributing and packaging, with lifetime serialization.

All of the non-all inclusive parameters above may be sourced, gathered, consolidated and catalogued by individual QR codes. The variable data in the database 953 can be downloaded from a planning or production MES system. In one form, data is automatically logged from the various systems which are part of the package creation, delivery and use. Alternatively or in addition, an operator can manually enter data before, during or after package creation.

The system 951 of FIG. 27 is for use with a continuous, in-line moving web 705 of successive product packages. Database device 953 stores a plurality of data records defining a plurality of different, unique, individual QR codes. A frame 702 for receiving and supporting the web of packages includes guides for guiding the web through the frame as the web moves through the frame. A printer 704 supported by the frame for printing the individual QR codes on the packages on-the-fly as the web moves through the frame. A tracking system such as camera 714 supported by the frame tracks the position of each product package of the web relative to the printer 704. A controller 961 linked to the database device 953, the printer 704, and the tracking system 714 controls the operation of the printer 704 to print the individual QR codes at a selected location on the packages formed from the web 705.

A parameter link to the database 953 provides to the database individual package parameters which are cross-referenced to the individual QR codes. As shown in FIG. 26, the parameter link comprises one or more of a link providing manufacturing parameters 955, a link providing material parameters 955, and a link providing distribution parameters 955. The parameter link can be a direct link with a processor of a manufacturing system 963, a processor of a materials system 965, and/or a processor of a distribution system 967. Alternatively and in addition, the parameter link can be an intermediate system or processor or a terminal used by an operator for manually providing parameter details.

An access link 969 to the database 953 provides entities access to at least some of the individual package parameters cross-referenced to each of the individual QR codes. The entities include but are not limited a materials supplier 971 of materials in the package, a package manufacturer 973, a brand owner 975 of a brand on a package, a retailer 977 selling a package, and a consumer 979 of the package.

In one form, the system includes a labeling device 718 such as illustrated in FIGS. 7, 8 and 13, linked to and controlled by the controller 761. The labeling device 718 is supported by the frame 702 for applying a removable layer to the packages over the individual QR codes on the packages. The controller 761 controls the operation of the labeling device 718 to apply one of the removable layers over the individual QR codes at the selected locations on the packages.

In one form, the system includes a distribution system (see FIG. 27) of a distributor 967 for collecting and distributing the packages to various locations such as retailers 977 according to the individual QR codes. The distribution system and/or the distributor 967 and/or the retailer 977 supplies individual package distribution parameters 959 to the database 953 via the parameter link. The supplied distribution parameters 959 are cross-referenced to the individual QR codes. In one form, the distribution system 963 includes a camera (not shown) reading the individual QR codes at the time of package distribution so the distribution parameters 959 can be tied to the QR code of the package.

The distribution parameters 959 comprise one or more of the following:
a SKU number of each package;
a destination of each package,
Handlers of each-package during the distribution process, and
a route by which each package is distributed, and
handling variables of each package during the distribution process (e.g., temperature).

In one form, the system includes a manufacturing system 963 of a manufacturer 973 for manufacturing the packages and for supplying individual package manufacturing parameters 955 to the database 953 via the parameter link. The supplied manufacturing parameters 955 are cross-referenced to the individual QR codes so that printing and manufacturing are coordinated as part of one in-line, on-the-fly system. In one form, the manufacturing system 963 includes a camera 981 reading the individual QR codes at the time of package manufacture so the manufacturing parameters 955 and the material parameters 957 can be tied to the QR code of the package.

The manufacturing parameters 955 comprise one or more of the following:
Package Size,
Package date and time of creation (e.g., Born on),
Expiration date of each package contents,
Operators/Handlers of each package,
Location of manufacture of package,
Actual weight of package,
Unique characteristics of each package,
Manufacturing process variables of each package (e.g., temperature, humidity, sterility, cook time), and
FDA reports relating to each package.

In one form, the system includes a materials system 965 for supplying materials for the individual packages and for supplying individual material parameters 957 to the database 953 via a parameter link. The supplied materials parameters 957 are cross-referenced to the individual QR codes.

The materials parameters 957 comprise one or more of the following:
Type of ingredients in each package,
Source of ingredients in each package,
Key ingredients in each package, and
Ingredient amounts in each package.

A network access link 969 (e.g., the Internet) provides to various entities access to selected data and selected records of each individual package based on the QR code of the package.

FIG. 27 illustrates one embodiment of a system of the invention for printing individual QR codes on individual consumer packages after the packages are manufactured. A database cross-references the QR code of each package to its unique package parameters. The package parameters includes one of more of manufacturing parameters, material parameters and/or distribution parameters.

A system 951A similar to the system 951 of FIG. 26 is illustrated in FIG. 27 for individual consumer product packages 954 which are labeled with QR codes after manufacture. The components in FIG. 27 which are the same as the components of FIG. 26 have been labeled with the same reference character. Thus, system 951A includes a database device 953 storing a plurality of data records defining a plurality of different, unique, individual QR codes. A printer 985 prints the variable QR codes on the packages 954. A controller 961 linked to the database device 953 and the printer 985 controls the operation of the printer 985 to print the individual QR codes at a selected location on the packages 954. A parameter link to the database 953 provides to the database 953 individual package parameters which are cross-referenced to the individual QR codes. An access link 969 to the database provides access to at least some of the individual package parameters cross-referenced to each of the individual QR codes.

Alternatively or in addition, each of the systems 951, 951A is adapted to be configured to provide one or more of the following:
A distributor 967 of a particular package has access to selected data of the particular package;
A retailer 977 of a particular package has access to selected data of the particular package;
A manufacturer 973 of a particular package has access to selected data of the particular package;
A materials supplier 971 of a particular package has access to selected data of the particular package;
A consumer 979 of a particular package has access to selected data of the particular package;
A brand owner 975 of a particular package has access to selected data of the particular package.

Alternatively or in addition, each of the systems 951, 951A is adapted to be configured to provide one or more of the following:
A distributor 967 of a particular package provides certain data (e.g., distribution parameters 959) for a particular package and has access to selected data of the particular package;
A retailer 977 of a particular package provides certain data (e.g., distribution parameters 959, marketing and/or sales parameters 959A such as package advantages, comparisons, discounts, incentives) for the particular package and has access to selected data of the particular package;
A manufacturer 973 of a particular package provides certain data (e.g., manufacturing parameters 955) for the particular package and has access to selected data of the particular package;
A materials supplier 971 of a particular package provides certain data (e.g., material parameters 957) for the particular package and has access to selected data of the particular package;
A consumer 979 of a particular package provides certain data (e.g., feedback parameters 959F such as ratings, package analysis, and preference) for the particular package and has access to selected data of the particular package; and
A brand owner 975 of a particular package provides certain data (e.g., marketing and/or sales parameters 959A such as package advantages, comparisons, discounts, incentives) for the particular package and has access to selected data of the particular package,
wherein each of the distribution, retailer, manufacturer, materials supplier, consumer and brand owner provides different certain data and accesses different selected data.

It is contemplated that access to the database 953 can be provided by several different portals. As noted above, the consumer 979 may access certain information by having a feature or application on their mobile device which scans an individual QR code of a particular package and, in response, links to the database 953, presenting the consumer with selected information regarding the particular package. Alternatively or in addition, a display of a grouping of packages may have a proximity beacon or an active RFID device which tracks mobile devices and alerts the consumer via an application or feature on their mobile device to scan a QR code of a particular package for more information.

For example, a mobile device of a consumer would provide an audible alert when receiving a signal from a Bluetooth beacon or other homing device. The consumer is prompted to scan one or more QR codes to find out information about various packages of a display, to compare packages having different models or options, and/or obtain purchase discounts or other incentives (e.g., points for a rewards program). The consumer may also be requested to analyze packages and provide feedback such as ratings or preferences which are stored in the database 953 and available to other entities on a selected basis.

A local Wi-Fi signal can also be used to engage a consumer via their mobile device. The Wi-Fi link would alert a consumer to use their mobile device to scan QR codes so that parameters connected to each unique, individual QR code would be delivered to the consumer from the database 953 via the Wi-Fi link. Those skilled in the art will recognize additional ways to engage consumers to (1) provide individualized package information or offers to consumer and/or (2) request information from consumers.

Thus, the systems herein are adapted to be configured to solicit consumer interaction with particular, individual packages, to sample new packages, and to promote package knowledge and sales.

The locations of the printers and cameras can be varied. For example, in FIG. 26 the camera 714 may be downstream the printer 704 along the web. Also, the printer 983 and camera 985 of FIG. 27 may have alternative positions. Alternatively or in addition, pre-existing printers and cameras of the manufacturing system 963 may be configured to print the individual QR codes on the individual packages, avoiding the need for a separate camera and printer.

Some of the features and benefits of systems such as illustrated in FIGS. 26 and 27 include but are not limited to:

1. Direct Mail—list driven, direct to household sample product mailing with key features being address on-pack via individual QR code of a particular package

### 2. Retail—Shopper Engagement

a. Multi-Layered instant, redeemable coupons (IRCs)
b. Cross Merchandising
c. Cross Marketing
d. Expiration Date Driven/Embedded Sell-By Date QR codes that drive increasing value couponing on-pack
e. Competitive Ingredients Tables On-pack—“Additive”

Cross Merchandising Ingredients Tables On-pack

### 3. Product Tracking/Grouping/Logistics—Intelligent Cartoning & Marking, Versioning, Route Sequenced Palletization

4. On demand print & apply labelling for a wide variety of retail, logistics, FDA conformance & accountability applications.
5. Camera based product identification, inspection, quality control, data archiving for accountability purposes.
6. Control of and creation of variable size packages on-the-Fly plus proportionately sized & applied package graphics.

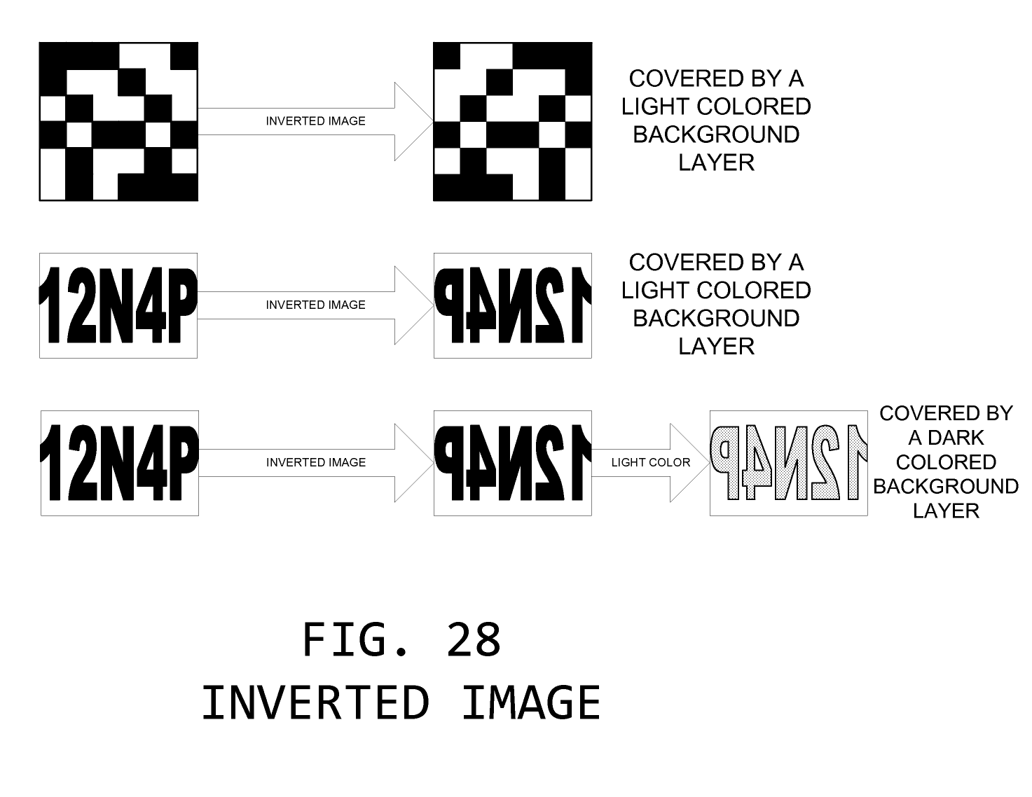

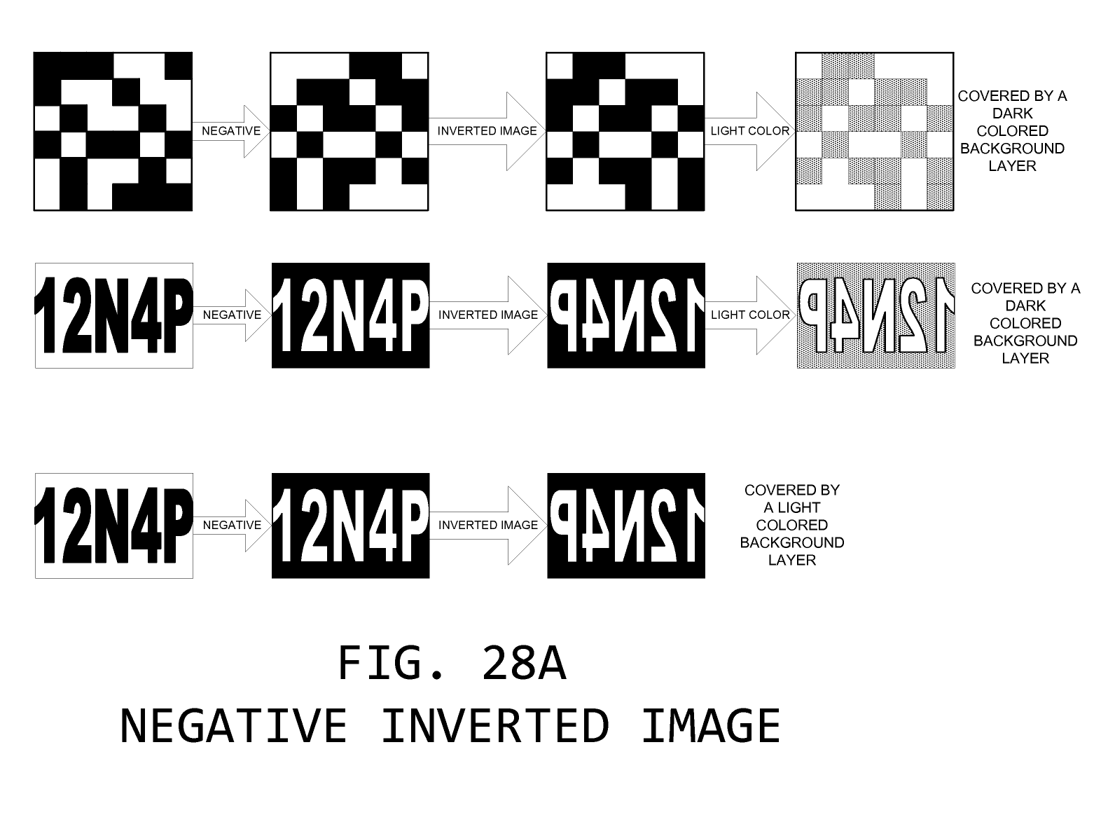

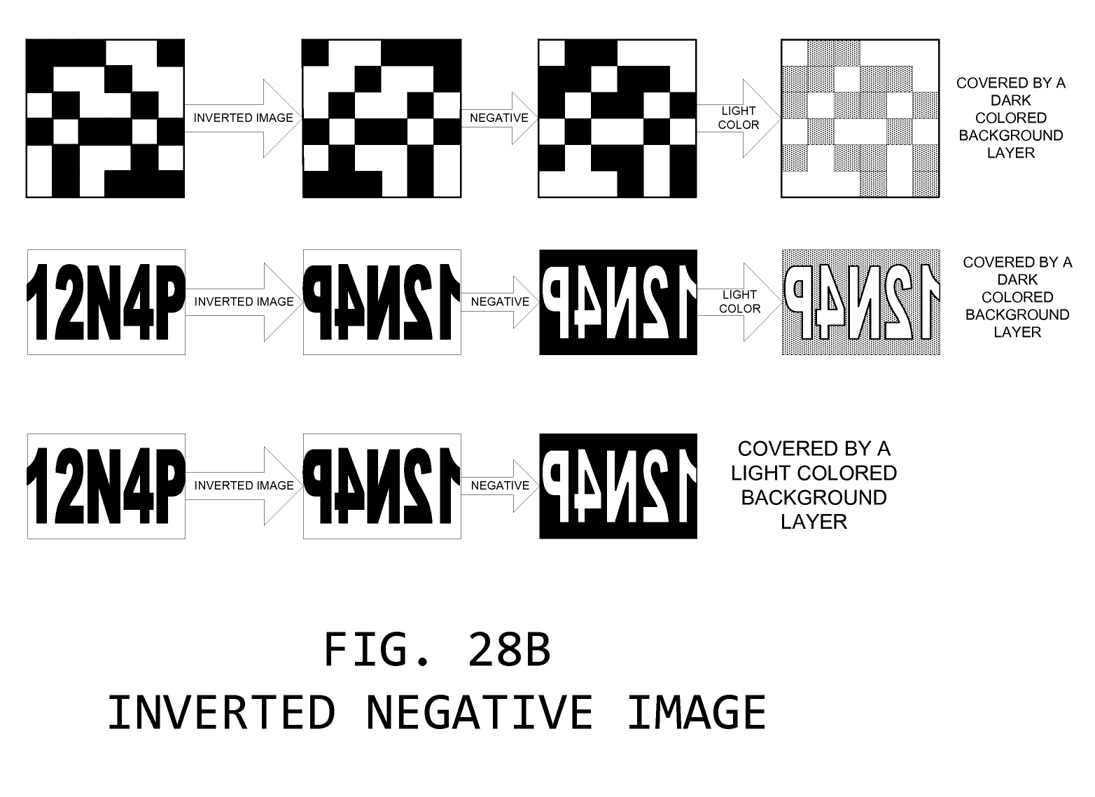

FIGS. 1-27 illustrate various embodiments in which individual, variable, unique codes are applied to individual packages to direct the distribution of each package, to provide promotions associated with each package, and to provide a database system of individual package parameters. FIGS. 28-31 illustrate various inverted codes which may be used with the embodiments of FIGS. 1-27. The codes of FIGS. 28-31 are printed on an exterior surface of a package, such as on a portion of the package which is transparent or translucent. The codes are covered by a background layer so that the codes can be read only from an interior of the package. The interior reading minimizes the risk of a code being read from an exterior of the package before a package is distributed, sold and opened. In addition, the application of the codes to the exterior surface of the packages eliminates the need to print on the interior surface of the package. Since printing on the interior surface of the package requires the use of food grade inks, the exterior printing avoids the need to use such food grade inks.

As used herein, an inverted image, also known as a reversed or mirror image, is an image which has undergone a rotation of 180 degrees about a vertical plane. In other words, the left and right margins of the object are reversed to create the inverted image. A positive image is a normal image. A negative image is a total inversion of the shading of an image, in which light areas appear dark and vice versa. The codes are inverted from the perspective of the exterior of a package. From the interior of a package, the codes are not inverted. A negative code is a code in which a light area is dark and a dark area is light. In some embodiments, the background is a lighter color than the code. In some embodiments, the background is a darker color than the code. In general, a color is considered lighter or darker if the color difference between the code and the background allows the code to be read or scanned, such as by an electronic code reader (e.g., a smart device having a camera and a code reading application). In general, there is a distinction (e.g., a contrast) between the code and the background so that the code can be differentiated from the background.

FIG. 28 includes exemplary images of inverted codes for printing on an exterior surface of transparent packaging. The inverted codes are overlaid by a background layer of ink on which text in is applied. The inverted codes are readable only from the interior of the transparent packaging.

FIG. 28A includes exemplary images of negative, inverted codes for printing on an exterior surface of transparent packaging. The negative, inverted codes are overlaid by a background layer on which text in is applied. The negative, inverted codes are readable only from the interior of the transparent packaging.

FIG. 28B includes exemplary images of inverted, negative codes for printing on an exterior surface of transparent packaging. The inverted, negative codes are overlaid by a background layer on which text in is print applied ed. The negative, inverted codes are readable only from the interior of the transparent packaging.

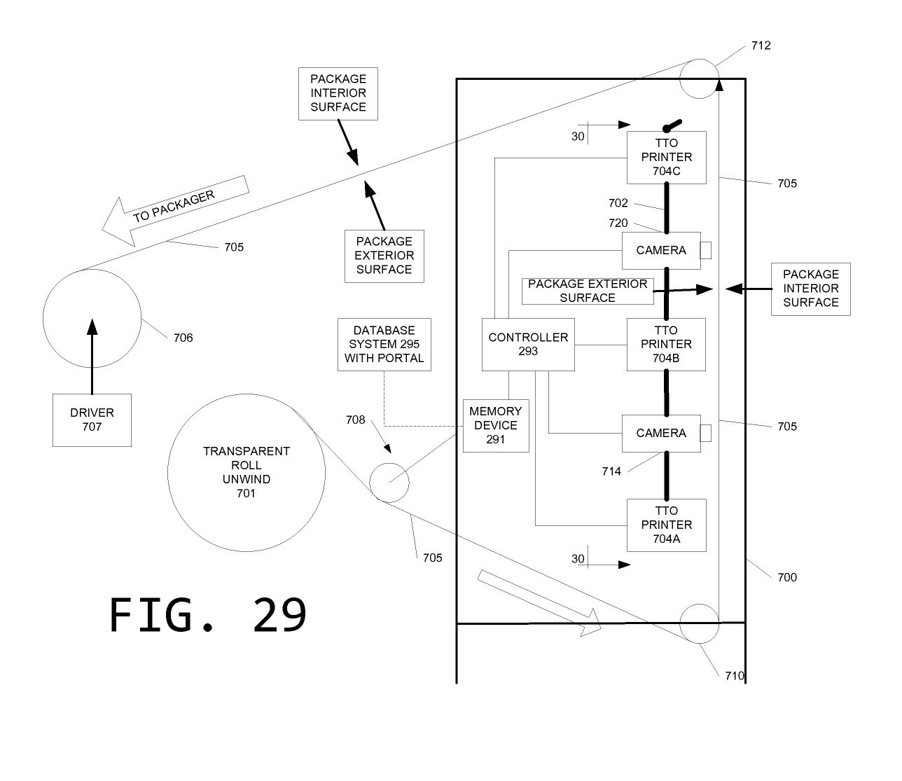

FIG. 29 illustrates a stand-alone module for use in conjunction with a typical roll of product packaging material (PPM) packages, according to another embodiment of the invention, in which a code, a background layer and text are sequentially applied to the exterior surface of a transparent portion of PPM.

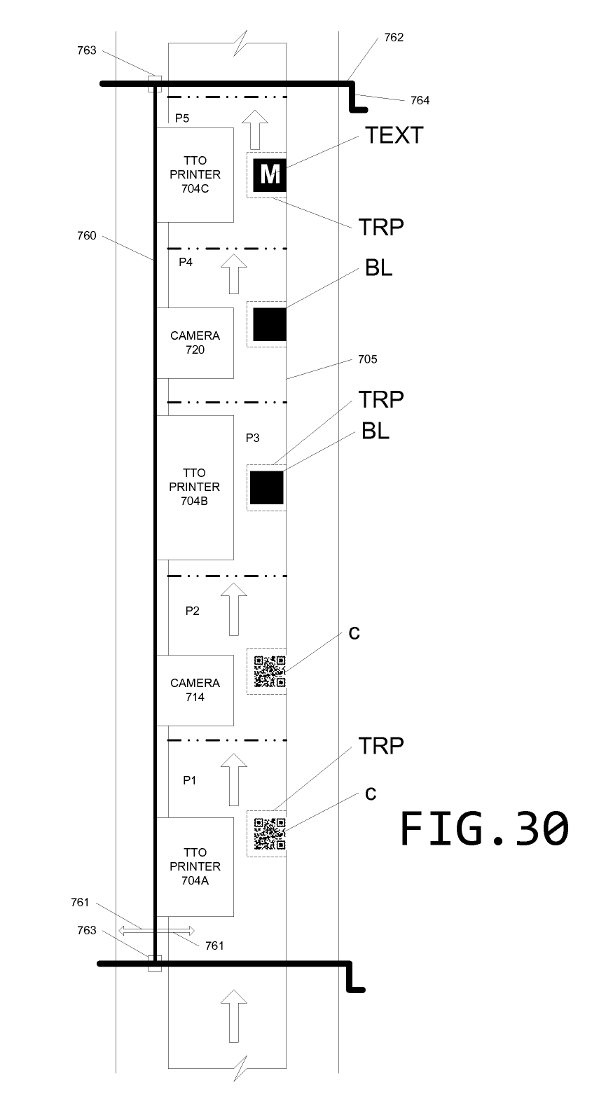

FIG. 30 is a view of the stand-alone module of FIG. 29 taken along lines 30-30 of FIG. 29, showing a QR code, a background layer applied over the QR code and a text message M applied on the background layer.

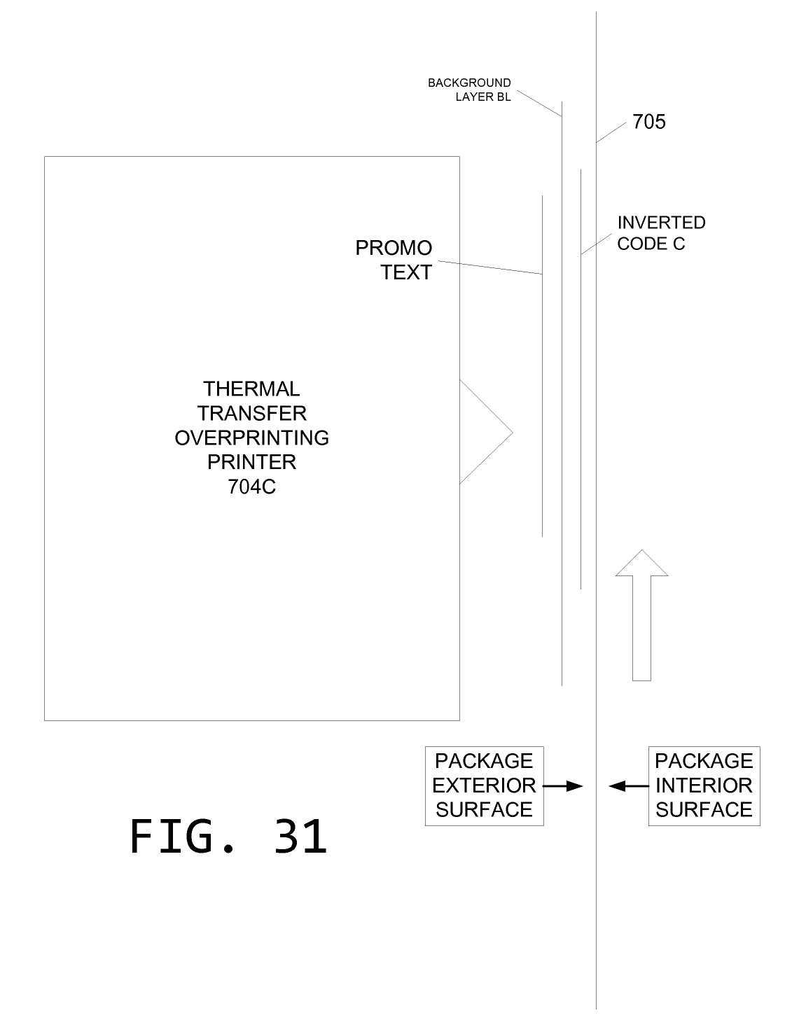

FIG. 31 is a partial side view of the thermal transfer overprinter and the web of PPM package after the code, background layer and text have been applied.

Referring to FIGS. 29-31, one embodiment of a system is provided for use with a continuous, in-line moving web 705 from which successive product packages are formed and filled with products. A memory device 291 stores a plurality of codes such as illustrated in FIGS. 28, 28A, and 28B. A frame 702 for receiving and supporting the web 705 of packages includes guides for guiding the web through the frame 702 as the web moves through the frame. A first printer 704A supported by the frame 702 prints a code C on an exterior surface of each package P1-P5 of the web 705 on-the-fly as the web moves through the frame. A second printer 704B supported by the frame 702 prints a background layer BL over (i.e., on top of) each printed code C on the exterior surface on each package P1-P5 on-the-fly as the web moves through the frame. A sensor (e.g., one or more cameras 714, 720) senses a position of the web relative to the printers. The sensor is linked to a system controller 293 which is linked to the memory device 291 and linked the printers 704A, 704B. The controller 293 controls the operation of the printers in response to the sensor to print a selected code C and background layer BL at positions along the web to provide individual, successive product packages on the web. Each package includes a code C overlaid by a background layer BL on the exterior surface of the package.

Optionally, the system includes a third printer 704C supported by the frame 702 for printing a layer of text T on the background layer BL of packages on-the-fly as the web moves through the frame. A database system 295 including memory device 291 stores the plurality of codes C printed on the web, at least some of the codes C having a corresponding promotion stored in the database. A portal is connected to the database system 295 through which access to the database system is provided to identify a particular code and any promotion corresponding thereto.

In one form, the web 705 has a transparent or translucent portion TRP, and the cameras 714, 720 sense the position of the portion relative to the first printer 704A. The controller 293 controls the first printer 704A in response to the cameras to print the code C on the portion.

For example, a unique, inverted QR code in black ink is printed by printer 704A on a transparent portion TRP of selected packages P of the web 705. A background layer BL in white ink is printed by printer 704B over the QR code to cover the QR code so that the QR code cannot be scanned or read from the exterior of the package and so that the QR code can only be scanned or read from the interior of the package. A promotional invitation (text) in multi-colored ink (other than white ink) is printed by printer 704C on the white background layer BL. The promotional invitation is the following text: SAVE $1.00 ON NEXT PURCHASE—SCAN CODE INSIDE PACKAGE. After a consumer obtains the package P, the consumer uses a smart phone with an QR Reader application (APP) or other scanner technology to scan the QR code from the inside of the package. The code links the consumer to a website portal of a database 295 which cross-references the QR code to a promotion. In this example, the consumer can download a $1.00 coupon in exchange for a completed survey or providing other information.

In one embodiment, the promotions in the database have restricted access. For example, the promotions are encrypted and only consumers who are registered with the system and have a decryption APP or other decryption software are provided access through the portal to decrypted promotions. By requiring consumers to register and log in to decrypt a promotion, information about the consumer and accounts of the consumer can be coordinated with purchases by the consumer and promotions redeemed by the consumer. For example, after a consumer obtains the package P, the consumer uses a smart phone with an QR Reader application (APP) or other scanner technology to scan the QR code from the inside of the package. The code links the consumer to a website portal of a database 295 which cross-references the QR code to an encrypted promotion. If the consumer is registered and logs in, the consumer can download a $1.00 coupon.

In another embodiment, the promotions in the database have restricted access. For example, only consumers who are registered with the system are provided access through the portal to promotions. By requiring consumers to register and log in to obtain a promotion, information about the consumer and accounts of the consumer can be coordinated with purchases by the consumer and promotions redeemed by the consumer. For example, after a consumer obtains the package P, the consumer uses a smart phone with an QR Reader application (APP) or other scanner technology to scan the QR code from the inside of the package. The code links the consumer to a website portal of a database 295 which cross-references the QR code to an promotion. If the consumer is registered and logs in, the consumer can download a $1.00 coupon.

As another example, a unique, inverted alphanumeric code in black ink is printed by printer 704A on a transparent portion TRP of selected packages P of the web 705. A background layer BL in white ink is printed by printer 704B over the alphanumeric code to cover the alphanumeric code so that the alphanumeric code cannot be scanned or read from the exterior of the package and so that the alphanumeric code can only be scanned or read from the interior of the package. A promotional invitation (text) in multi-colored ink (other than white ink) is printed by printer 704C on the white background layer BL. The promotional invitation is the following text: SAVE $1.00 ON NEXT PURCHASE—SCAN CODE INSIDE PACKAGE. After a consumer obtains the package P, the consumer read the alphanumeric code from inside the package. Below the code is a URL address to a website portal. The consumer enters the code at the portal which is connected to a database 295 which cross-references the alphanumeric code to a promotion. In this example, the consumer can download a $1.00 coupon in exchange for a completed survey or providing other information.

As illustrated in FIGS. 28, 28A and 28B, the code can take various forms. For example, the code comprises at least one of:
an inverted image of a standard code (FIG. 28);
an inverted negative image of a standard code (FIG. 28B); and
a negative inverted image of a standard code (FIG. 28A).

In some forms, at least one of the following:
the code is an inverted code and the background layer is an opaque, lighter color than the inverted code (FIG. 28, first and second rows);
the code is an inverted code and the background layer is an opaque, darker color than the inverted code (FIG. 28, third row);
the code is a negative, inverted code and the background layer is an opaque, lighter color than the inverted code (FIG. 28A, third row; FIG. 28B, third row); and
the code is a negative, inverted code and the background layer is an opaque, darker color than the inverted code (FIG. 28A, first and second rows; FIG. 28B, first and second rows).

In some forms, at least one of the following:
the code is an inverted code in black ink and the background layer is an opaque, lighter color than black (FIG. 28, first and second rows);
the code is an inverted code in color other than black and the background layer is an opaque layer of black ink (FIG. 28, third row);
the code is a negative, inverted code in black ink and the background layer is an opaque, lighter color than black (FIG. 28A, third row; FIG. 28B, third row); and
the code is a negative, inverted code other than black and the background layer is an opaque layer of black ink (FIG. 28A, first and second rows; FIG. 28B, first and second rows).

In one form, at least one of the following: the code is an inverted code of a particular ink and the background layer is an opaque, contrasting color to the particular ink (FIG. 28); and the code is a negative, inverted code of a particular ink and the background layer is an opaque, contrasting color to the particular ink (FIGS. 28A and 28B).

For example, the code comprises at least one of a QR code, a bar code, alphanumeric characters, an inverted QR code, an inverted bar code, and inverted alphanumeric characters.

In one form, a method is provided for use with a continuous, in-line moving web from which successive product packages are formed and filled with products. The method comprises the steps of:
providing a memory device 291 storing a plurality of codes C;
first printing a code C (by a printer 704A) on an exterior surface of each package P on-the-fly as the web 705 moves;
second printing a background layer BL (by a printer 704B) over each printed code C on the exterior surface on each package P on-the-fly as the web 705 moves; sensing a position of the web (by one or more cameras 714, 720); and
controlling the first printing and the second printing (by controller 293) in response to the sensing (by one or more cameras 714, 720) to print a selected code C and background layer BL at positions along the web 705 to provide individual, successive product packages P on the web wherein each package includes a code C overlaid by a background layer BL on the exterior surface of the package.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or computer-executable instructions, such as program modules, stored one or more tangible computer storage media and executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computers and/or servers may execute the computer-executable instructions such as those illustrated herein to implement aspects of the invention.

Embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

The Abstract and summary are provided to help the reader quickly ascertain the nature of the technical disclosure. They are submitted with the understanding that they will not be used to interpret or limit the scope or meaning of the claims.

What is claimed is:

1. A system for use with a continuous, in-line moving web from which successive product packages are formed and filled with products, said system comprising:
a memory device storing a plurality of codes;
a frame for receiving and supporting the web of packages including guides for guiding the web through the frame as the web moves through the frame;
a first printer supported by the frame for printing a code on an exterior surface of each package on-the-fly as the web moves through the frame;
a second printer supported by the frame for printing a background layer over each printed code on the exterior surface on each package on-the-fly as the web moves through the frame;
a sensor for sensing a position of the web relative to the printers; and
a system controller linked to the sensor, linked to the memory device, and linked the printers, said controller for controlling the operation of the printers in response to the sensor to print a selected code and background layer at positions along the web to provide individual, successive product packages on the web wherein each package includes a code overlaid by a background layer on the exterior surface of the package.

2. The system of claim 1 further comprising a third printer supported by the frame for printing a layer of text on the background layer of packages on-the-fly as the web moves through the frame.

3. The system of claim 1 wherein the web has a transparent or translucent portion, wherein the sensor senses the position of the portion relative to the first printer, and wherein the controller controls the first printer in response to the sensor to print the code on the portion.

4. The system of claim 3 wherein the code comprises at least one of:
an inverted image of a standard code;
an inverted negative image of a standard code; and
a negative inverted image of a standard code.

5. The system of claim 3 wherein at least one of:
the code is an inverted code and the background layer is an opaque, lighter color than the inverted code;
the code is an inverted code and the background layer is an opaque, darker color than the inverted code;
the code is a negative, inverted code and the background layer is an opaque, lighter color than the inverted code; and
the code is a negative, inverted code and the background layer is an opaque, darker color than the inverted code.

6. The system of claim 3 wherein at least one of:
the code is an inverted code in black ink and the background layer is an opaque, lighter color than black;
the code is an inverted code in color other than black and the background layer is an opaque layer of black ink;
the code is a negative, inverted code in black ink and the background layer is an opaque, lighter color than black; and
the code is a negative, inverted code other than black and the background layer is an opaque layer of black ink.

7. The system of claim 3 wherein at least one of:
the code is an inverted code of a particular ink and the background layer is an opaque, contrasting color to the particular ink; and
the code is a negative, inverted code of a particular ink and the background layer is an opaque, contrasting color to the particular ink.

8. The system of claim 3 wherein the code comprises at least one of a QR code, a bar code, alphanumeric characters, an inverted QR code, an inverted bar code, and inverted alphanumeric characters.

9. The system of claim 1 further comprising:
a database storing the plurality of codes printed on the web, at least some of the codes having a corresponding promotion stored in the database;
a third printer supported by the frame for printing a layer of text relating to the promotion on the background layer of packages on-the-fly as the web moves through the frame; and
a portal connected to the database through which access to the database is provided to identify a particular code and any promotion corresponding thereto.

10. The system of claim 9 wherein the web has a transparent or translucent portion, wherein the sensor senses the position of the portion relative to the first printer, and wherein the controller controls the first printer in response to the sensor to print the code on the portion.

11. A method for use with a continuous, in-line moving web from which successive product packages are formed and filled with products, said method comprising the steps of:
providing a memory device storing a plurality of codes;
first printing a code on an exterior surface of each package on-the-fly as the web moves;
second printing a background layer over each printed code on the exterior surface on each package on-the-fly as the web moves;
sensing a position of the web; and
controlling the first printing and the second printing in response to the sensing to print a selected code and background layer at positions along the web to provide individual, successive product packages on the web wherein each package includes a code overlaid by a background layer on the exterior surface of the package.

12. The method of claim 11 further comprising the step of third printing a layer of text on the background layer of packages on-the-fly as the web moves through the frame.

13. The method of claim 11 wherein the web has a transparent or translucent portion, wherein the sensing senses the position of the portion, and wherein the controlling controls the first printing in response to the sensing to print the code on the portion.

14. The method of claim 13 wherein the code comprises at least one of:
an inverted image of a standard code;
an inverted negative image of a standard code; and
a negative inverted image of a standard code.

15. The method of claim 13 wherein at least one of:
the code is an inverted code and the background layer is an opaque, lighter color than the inverted code;
the code is an inverted code and the background layer is an opaque, darker color than the inverted code;
the code is a negative, inverted code and the background layer is an opaque, lighter color than the inverted code; and
the code is a negative, inverted code and the background layer is an opaque, darker color than the inverted code.

16. The method of claim 13 wherein at least one of:
the code is an inverted code in black ink and the background layer is an opaque, lighter color than black;
the code is an inverted code in color other than black and the background layer is an opaque layer of black ink;
the code is a negative, inverted code in black ink and the background layer is an opaque, lighter color than black; and
the code is a negative, inverted code other than black and the background layer is an opaque layer of black ink.

17. The method of claim 13 wherein at least one of:
the code is an inverted code of a particular ink and the background layer is an opaque, contrasting color to the particular ink; and
the code is a negative, inverted code of a particular ink and the background layer is an opaque, contrasting color to the particular ink.

18. The method of claim 13 wherein the code comprises at least one of a QR code, a bar code, alphanumeric characters, an inverted QR code, an inverted bar code, and inverted alphanumeric characters.

19. The method of claim 11 further comprising:
storing the plurality of codes printed on the web in a database, at least some of the codes having a corresponding promotion stored in the database;
printing a layer of text relating to the promotion on the background layer of packages on-the-fly as the web moves through the frame; and
providing a portal connected to the database through which access to the database is provided to identify a particular code and any promotion corresponding thereto.

20. The method of claim 19 wherein the web has a transparent or translucent portion, wherein the sensing senses the position of the portion, and wherein the controlling controls the first printing in response to the sensor to print the code on the portion.
